(19) United States
(12) Patent Application Publication
(10) Pub. No.: US 2018/0107784 A1
(43) Pub. Date: Apr. 19, 2018

(54) EVALUATING AND CALLING SEQUENCES

(71) Applicant: REAL TIME GENOMICS LIMITED, Hamilton (NZ)

(72) Inventors: John Gerald CLEARY, Hamilton (NZ); Sean A. IRVINE, Hamilton (NZ); Kurt Oliver GAASTRA, Hamilton (NZ); Leonard Eric TRIGG, Ngahinapouri (NZ)

(21) Appl. No.: 15/794,915

(22) Filed: Oct. 26, 2017

Related U.S. Application Data
(63) Continuation-in-part of application No. 13/971,630, filed on Aug. 20, 2013, now abandoned.
Application No. 13/971,630 is a continuation-in-part of application No. 13/971,654, filed on Aug. 20, 2013, now abandoned.
(60) Provisional application No. 61/691,271, filed on Aug. 21, 2012.
(60) Provisional application No. 61/729,462, filed on Nov. 23, 2012.
(60) Provisional application No. 61/803,671, filed on Mar. 20, 2013.
(60) Provisional application No. 61/691,271, filed on Aug. 21, 2012.
(60) Provisional application No. 61/729,462, filed on Nov. 23, 2012.
(60) Provisional application No. 61/803,671, filed on Mar. 20, 2013.

(51) Int. Cl. G06F 19/22; G06F 19/28; G06F 19/18

(52) U.S. Cl. CPC G06F 19/22; G06F 19/18; G06F 19/28

(57) ABSTRACT

Methods and systems for simultaneously evaluating genomic or biological sequences across multiple population members, and methods and systems for simultaneously calling normal and cancerous genomic or biological sequences from a mixed sample containing normal and cancerous material are disclosed. This may be achieved by evaluating the probability of one or more hypothesis being correct for a plurality of population members based on genomic or biological sequence information for the population. For related family members, Mendelian inheritance may be integrated into the method. For populations, information from members under evaluation may be used to refine priors to more accurately call population members. Copy number variation, de novo mutations, and phenotypic traits and their genetic explanations may also be accommodated in the methods. Specific systems for implementing the methods are also disclosed.

### CROSS-REFERENCE TO RELATED APPLICATIONS

This application is a Continuation-in-Part of U.S. patent application Ser. No. 13/971,654, filed on Aug. 20, 2013, and also a Continuation-in-Part of U.S. patent application Ser. No. 13/971,630, filed on Aug. 20, 2013, both of which further claim the benefit of U.S. Provisional Application No. 61/691,271, filed on Aug. 21, 2012; U.S. Provisional Application No. 61/729,462, filed on Nov. 23, 2012; and U.S. Provisional Application No. 61/803,671, filed on Mar. 20, 2013. Each of the above disclosed applications are hereby incorporated by reference in their entireties. Additionally, to the extent appropriate, a claim of priority is made to each of the above disclosed applications.

### SUMMARY

The inventions described herein relate to methods for simultaneously evaluating genomic or biological sequences, including cancer-related sequences, and systems therefor. The methods and systems additionally may incorporate Mendelian inheritance among related family members. The inventions also relate to probability-based calling methods suitable for use in calling sequences for reads obtained from samples containing both normal and cancerous material. There are also disclosed methods incorporating copy number variation into probability-based calling methods. There are also disclosed methods incorporating phenotypic traits and genetic explanations for the traits, as well as integrated systems incorporating each individual modeling feature into single systems.

There have been great advances in genomic sequencing in recent times. Sequencing machines can generate reads ever more rapidly with increasingly accurate results. However, there remain errors in the reads produced and during the process of read alignment the reads must be assembled as best as possible to generate the most accurate genomic sequence for the sample possible. The process of “calling” a value of the sequence from the reads requires consideration of a range of relevant factors and potential sources of errors.

Additionally, there has been much research to identify predisposing genomic sequence variants and somatic mutations. The basis for this research is the accurate calling of cancerous sequences obtained from tumors and related samples. However, many samples have included a mixture of normal genomic or biological sequences and cancerous genomic or biological sequences and the quality of calling has been reduced for such mixed samples as the reads for the normal samples act as contamination of the cancerous samples.

A wide range of algorithms for calling sequence values have been employed. Some use filtering techniques but this potentially loses information that may assist in making a call or values that upon more thorough investigation may be the best calls. Mendelian inheritance rules have been used to investigate family relationships but have not been fully exploited. Prior approaches have not looked to other family members as part of a larger dynamic model. Such approaches have had limited success in correctly identifying the likelihood of de novo mutations.

Other techniques for calling biological sequences include prior U.S. Pat. No. 7,640,256 and U.S. patent application Ser. Nos. 13/129,329 and 61/695,408, and PCT/NZ2011/000080, PCT/NZ2011/000081 and PCT/NZ2011/000197, all of which are hereby incorporated by reference in their entireties for any and all purposes.

Some prior calling techniques may assume that the sample is uncontaminated (i.e. either all normal or all cancerous material) and have not been able to make accurate calls for mixed samples of cancerous and normal biological material or where there is copy number variation (which is common with cancer).

It would be desirable to improve the quality of calling by utilizing population information in an integrated model. It would also be desirable to improve the quality of calling for mixed samples or where there is copy number variation.

It is an object of the disclosed inventions to provide improved methods of calling biological sequences that overcome at least some of these problems.

In some embodiments, the invention provides a method of calling a genomic sequence for a sample from a biological entity in a collection of related biological entities, performed by one or more processors executing program instructions stored on one or more memories, causing the one or more processors to perform the method comprising: obtaining genomic sequence information for one or more samples from one or more biological entities; performing read alignments to generate preliminary alignments for the samples; identifying a region of interest for the alignments; developing hypotheses as to sequence values in the region of interest; and evaluating the probability of one or more hypothesis being correct for a plurality of sequence values based on the genomic sequence information.

In some embodiments, the invention provides a system for calling a genomic sequence for a sample from a biological entity in a collection of related biological entities, the system comprising: one or more processors configured to execute one or more modules; and a memory storing the one or more modules, the modules comprising: code for obtaining genomic sequence information for one or more samples from one or more biological entities; code for performing read alignments to generate preliminary alignments for the samples; code for identifying a region of interest for the alignments; code for developing hypotheses as to sequence values in the region of interest; and code for evaluating the probability of one or more hypothesis being correct for a plurality of sequence values based on the genomic sequence information.

In some embodiments, the invention provides a method of calling a genomic sequence for a sample from a subject potentially containing normal and cancerous material, performed by one or more processors executing program instructions stored on one or more memories, causing the one or more processors to perform the method comprising: sequencing the potentially mixed sample of normal and cancerous genomic material to obtain reads for the sample; performing read alignments to generate preliminary alignments for the samples; identifying a region of interest for the alignments; developing hypotheses as to sequence values in the region of interest; and evaluating the probability of normal sequence and cancerous sequence values based on the reads, normal genomic sequence information, and a contamination factor.

In some embodiments, the invention provides a method of calling a target biological sequence of a biological sequence source based on a set of sequence reads, the method performed by one or more processors executing program instructions stored on one or more memories, the instructions causing the one or more processors to perform the method comprising: obtaining biological sequence read information from a target biological sequence source and a second biological sequence source, wherein the target source and the second source are genetically related; modeling probabilities of occurrence of possible values of a set of random variables using a Bayesian network, the set of random variables comprising: a set of sequence reads that correspond to the target biological sequence source; a biological sequence of the target biological sequence source; a set of sequence reads that correspond to the second biological sequence source; and a biological sequence of the second biological sequence source; and one or more random variables chosen from: contamination of a set of sequence reads that correspond to a biological sequence source; the copy number of a genomic sequence of a biological sequence source; the presence of de novo mutation in a genomic sequence of a biological sequence source; and a phenotypic trait; and providing one or more likely values for one or more random variables in the set of random variables.

In some embodiments, the invention provides a method of calling a target biological sequence of a biological sequence source based on a set of sequence reads, the method performed by one or more processors executing program instructions stored on one or more memories, the instructions causing the one or more processors to perform the method comprising: obtaining biological sequence read information from a target biological sequence source and a second biological sequence source, wherein the target source and the second source are genetically related, and wherein the target source and the second source are not two members of a family of individual organisms; modeling probabilities of occurrence of possible values of a set of random variables using a Bayesian network, the set of random variables comprising: a set of sequence reads that correspond to the target biological sequence source; a biological sequence of the target biological sequence source; a set of sequence reads that correspond to the second biological sequence source; a biological sequence of the second biological sequence source; and a variable representing contamination of a set of sequence reads that correspond to a biological sequence source; and providing one or more likely values for one or more random variables in the set of random variables.

In some embodiments, the invention provides a system for calling a target biological sequence of a biological sequence source based on a set of sequence reads, the system comprising: one or more processors configured to execute one or more modules; and a memory storing the one or more modules, the modules comprising: code for obtaining biological sequence read information from a target biological sequence source and a second biological sequence source, wherein the target source and the second source are genetically related; code for modeling the probabilities of occurrence of the possible values of a set of random variables using a Bayesian network, the set of random variables comprising: a set of sequence reads that correspond to the target biological sequence source; a biological sequence of the target biological sequence source; a set of sequence reads that correspond to the second biological sequence source; and a biological sequence of the second biological sequence source; and one or more random variables chosen from: contamination of a set of sequence reads that correspond to a biological sequence source; the copy number of a biological sequence of a biological sequence source; the presence of de novo mutation in a biological sequence of a biological sequence source; and a phenotypic trait; and code for providing one or more likely values for the biological sequence of the target source and/or one or more likely values for the biological sequence of the second biological sequence source.

Additional objects and advantages of the invention will be set forth in part in the description that follows.

It is acknowledged that the terms “comprise,” “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

Reference to any prior art in this specification does not constitute an admission that such prior art forms part of the common general knowledge.

It is to be understood that both the foregoing general description and the following detailed description are exemplary and explanatory only and are not restrictive of the invention, as claimed.

### BRIEF DESCRIPTION OF THE DRAWINGS

Reference will now be made to the accompanying drawings showing example embodiments of this disclosure. In the drawings:

FIG. 1 shows a family diagram modeling a mother, father, and single child, consistent with embodiments of the present disclosure.

FIG. 2 shows a family diagram modeling a mother, father, and four children, consistent with embodiments of the present disclosure.

FIG. 3 shows a model illustrating forward and backward propagation of model values in an exemplary monogamous family, consistent with embodiments of the present disclosure.

FIG. 4 shows a model illustrating forward and backward propagation of model values in an exemplary non-monogamous family, consistent with embodiments of the present disclosure.

FIG. 5 shows a model illustrating the order of execution in the forward backward algorithm as applied to an exemplary non-monogamous family, consistent with embodiments of the present disclosure.

FIG. 6 illustrates exemplary hardware components that can be used to solve or approximate the values of variables represented in certain embodiments, consistent with embodiments of the present disclosure.

FIG. 7 shows a hardware configuration suitable for computing the final normalized probabilities of the hypotheses.

FIG. 8 shows a hardware configuration suitable for computing the A_{c} value for a child in a single-child family. This example takes as inputs the A values and S values for the parents

FIG. 9 is a hardware configuration suitable for computing the Bₘ value for a mother in a single-child family. This example takes as inputs the A values and S values for the father and the child.

FIG. 10 shows a neural network for performing pedigree variant analysis.

FIG. 11 is an exemplary Bayesian Network that represents the copy numbers (C) and genotypes (G) for one or more samples given the sets of reads (S) for those samples in a singleton calling context, consistent with embodiments of the present disclosure.

FIG. 12 is an exemplary Bayesian Network in which a set of reads appears as individual reads (Rᵢ), consistent with embodiments of the present disclosure.

FIG. 13 shows an abbreviation that will sometimes be used when illustrating certain embodiments, such as those involving large Bayesian networks such as pedigrees. It can be used to indicate this common combined network including S (or R), G, C, N, B, and M.

FIG. 14 is an exemplary Bayesian Network that represents the case where one sample is known to be descended from a single other sample including random variables for the copy number of the original and descendant samples, consistent with embodiments of the present disclosure.

FIG. 15 is an exemplary Bayesian Network that represents the case where the possibility of mutation is integrated into the network of FIG. 14, consistent with embodiments of the present disclosure.

FIG. 16 is an exemplary Bayesian Network that represents multiple branching descendants, consistent with embodiments of the present disclosure.

FIG. 17 is an exemplary Bayesian Network that represents a sequence of multiple descendants, consistent with embodiments of the present disclosure.

FIG. 18 is an exemplary Bayesian Network that represents a pedigree containing multiple descendants, showing both branching and a series of generations, consistent with embodiments of the present disclosure.

FIG. 19 is an exemplary Bayesian Network that incorporates a random variable (A₁) that models contamination, consistent with embodiments of the present disclosure.

FIG. 20 is an exemplary Bayesian Network representing a family with two parents and one child, consistent with embodiments of the present disclosure.

FIG. 21 is an exemplary Bayesian Network representing a family with two parents and multiple children, consistent with embodiments of the present disclosure.

FIG. 22 is an exemplary Bayesian Network representing an extended pedigree with multiple generations, consistent with embodiments of the present disclosure.

FIG. 23 is an exemplary Bayesian Network representing a family with two parents and one child, expanded to explicitly allow for copy number and genotype mutations, consistent with embodiments of the present disclosure.

FIG. 24 is an exemplary Bayesian Network representing a family with two parents and one child, expanded to explicitly allow for phenotypic traits (D) and the explanation (U), consistent with embodiments of the present disclosure.

FIG. 25 is an exemplary Bayesian Network representing a family pedigree that illustrates how one or more of the disclosed networks can be combined in a unified model, consistent with embodiments of the present disclosure.

### DETAILED DESCRIPTION

When developing a representation of a genomic or biological sequence from a biological sample sequencing machines produce many reads of short portions of the subject genomic or biological sequence (typically DNA, RNA or proteins). These reads (genomic or biological sequence information) must be aligned and then “calls” must be made as to values of the sequence at each location (e.g., individual bases for DNA). There may typically be only a few reads (and sometimes none) at a particular location or very many reads in others.

Errors can arise in process of sequencing genomes. In some cases all reads are consistent or “simple calls” may be made using conventional calling techniques. There are typically “regions of interest” that may span a single or several values where more sophisticated analysis can be required to make a reliable call. A region may be identified as a region of interest, as the confidence in calling the region may be too low using simple calling techniques or there may be characteristics of the region indicating deeper analysis is desirable. These characteristics may be numbers of insertions and/or deletions, the value and proximity of calls (e.g. a number of low confidence calls close to each other) etc.

The problems are compounded when, for example:
(1) The sample includes both genomic information relating to normal and cancerous biological material; and/or
(2) The number of copies of parts of the genomic sequence varies (i.e. in cancerous cells more copies of parts of the DNA may be present than others—a phenomenon known as copy number variance).

A Bayesian approach may be applied to resolve calls in such regions of interest. This is a principled way of combining multiple factors and allows evolving knowledge to be dynamically integrated.

Such regions of interest can be evaluated without reference to family members or a related population. Such regions of interest can also be evaluated without taking into account contamination (mixed normal and cancerous biological samples) or copy number variation (certain portions of the genomic sequence may have more copies due to a cancer). But the exclusion of family member, related population, and contamination information removes a large volume of information that can assist in making reliable calls in difficult regions. Accordingly, in certain embodiments, the reads for multiple samples may be evaluated simultaneously so that all information is utilized to inform the calling of genomic or biological sequences for each sample and provide more accurate calling. Additionally, in certain embodiments, the model is adjusted to account for contamination and/or copy number variation to improve the accuracy of calling genomic sequences.

### 1. SIMULTANEOUSLY EVALUATING MULTIPLE GENOMIC SEQUENCES

In certain embodiments, a Bayesian model can be applied to calling a genomic sequence. For example, the probability of a hypothesis (proposed sequence values for the region of interest) being correct given the data (reads) is the normalized value of the probability of the hypothesis occurring (prior) times the probability of the data occurring given the hypothesis (model) which may be expressed as:

$$P ( H \vert D ) = \frac{P ( H ) \times P ( D \vert H )}{\sum P ( H ) \times P ( D \vert H )} \qquad ( Equation 1 )$$

where:
P(H|D) is the probability of a hypothesis H being correct for all members given data D,
P(H) is the probability of the hypothesis occurring, independent of the data D,
P(D|H) the probability of the data D occurring given the hypothesis, and
ΣP(H)×P(D|H) is the sum of all probabilities for all hypotheses, which is used to normalize the results.

For a population of k members this may be expressed as:

$$P ( H \vert D ) = \frac{P ( \prod {H}_{k} ) \times \prod P ( {D}_{k} \vert {H}_{k} )}{\sum P ( \prod {H}_{k} ) \times \prod P ( {D}_{k} \vert {H}_{k} )} \qquad ( Equation 2 )$$

where:
P(H|D) is the probability of a hypothesis H (consisting of the k sequences hypothesized for the k population members) being correct for all members given data D (being the reads for all k members),
P(ΠHₖ) is the probability of a hypothesis for the k population members occurring, independent of the data D,
ΠP(Dₖ|Hₖ) is the probability of the data D (i.e. the reads for all k members) occurring given the hypothesis (consisting of the k sequences hypothesized for the k population members), and
ΣP(ΠHₖ)×ΠP(Dₖ|Hₖ) is the sum of all probabilities for all hypotheses across all values, which is used to normalize the results.

For a population, an expectation maximization (EM) algorithm may be employed to improve calling accuracy. The algorithm may enhance calling by utilizing population prior information to refine calling. This may be performed by:

(a) calling sequences for population members based on historical probability data as to the probability of a hypothesis occurring;
(b) combining the called sequences for population members with the historical probability data to produce combined historical data;
(c) re-calling sequences for population members based on the combined historical data as to the probability of a hypothesis occurring;
(d) repeating steps (b) and (c) until a desired convergence is achieved.

In step (b) the called sequence information may be combined with the historical probability data based on the probability of a haploid sequence occurring. This may assist in achieving rapid convergence. Alternatively the called sequence information may be combined with the historical probability data based on the probability of a diploid sequence occurring. Steps (b) and (c) may be repeated until there is no change in sequence calling or when some other criteria is met.

### 1.1. Mendelian Inheritance

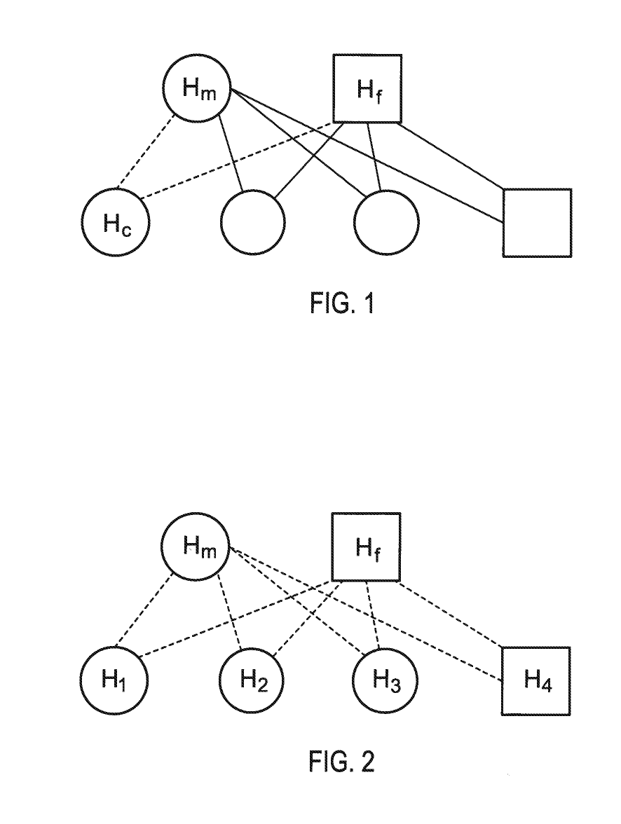

In certain embodiments, where a family is being evaluated, such as illustrated in FIG. 1, Mendelian inheritance information may be incorporated into the model. Applying Equation 2 to a nuclear family of a mother (m) a father (f) and a child (c), it becomes:

$$P ( H \vert D ) = \frac{\begin{matrix}P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}}{\begin{matrix}\sum P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}} \qquad ( Equation 3 )$$

which may be re-expressed as:

$$P ( H \vert D ) = \frac{\begin{matrix}P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}}{\begin{matrix}\sum P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}} \qquad ( Equation 4 )$$

where:
P(H|D) is the probability of a hypothesis (H) being correct for all members given data D,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (H_{f}),
P(D_{c}|H_{c}) is the probability of the genomic sequence information for a child (D_{c}) occurring for the hypothesis for the child (H_{c}),
P(Hₘ) is the probability of the hypothesis occurring for the mother, independent of the data D,
P(H_{f}) is the probability of the hypothesis occurring for the father, independent of the data D,
M(H_{c}|Hₘ,H_{f}) is the Mendelian probability of the hypothesis for the child given the hypotheses for the parents, and
ΣP(Dₘ|Hₘ)×P(D_{f}|H_{f})×P(D_{c}|H_{c})×P(Hₘ)×P(H_{f})×M(H_{c}|Hₘ×H_{f}) is the sum of all probabilities over all possible combinations of hypotheses for the parent and child used to normalize probabilities.

### 1.2. De Novo Mutations

The Mendelian probability of the hypothesis for the child given the hypotheses for the parents M(H_{c}|Hₘ, H_{f}) may be a simple Mendelian probability or may be a modified form that takes into account non-Mendelian mechanisms. In particular the probabilities associated with de novo mutations may be incorporated into the Mendelian probability M(H_{c}|Hₘ, H_{f}).

In certain embodiments, the probability of de novo mutations may be influenced by population factors (such as species information and the age of the parents), and environmental factors (such as radiation exposure, feed sources, climatic conditions, etc).

One way of constructing a modified Mendelian table M′(H_{c}|Hₘ, H_{f}) is to assume that there is some small probability μ of a single nucleotide being mutated and that both nucleotides are never mutated at the same time (because μ can be very small). Then the various values in M′ can be computed from the original M. For example:

M′(A:C|A:A,A:A)=2μ/3×M(A:A|A:A,A:A)

M′(A:A|A:A,A:A)=(1−2μ)×M(A:A|A:A,A:A)

In this way even though the probability of a de novo mutation may be very low, information across a family may be utilized to reveal the significance of anomalous data in a subject that may reveal a de novo mutation. A de novo mutation may be identified where the probability of an hypothesis for a de novo mutation is greater than for any other hypothesis or according to other prescribed criteria. In some cases a likelihood of a de novo mutation above a certain level may be flagged so that the region of interest may be further analyzed.

### 1.3. Contamination

In certain embodiments, a sample is obtained from a location expected to have predominantly normal genomic material (e.g. a blood sample) and another is obtained from a region where it is suspected that cancerous genomic material is present. The two samples are sequenced by a sequencing machine to produce sets of reads for each sample. It will be appreciated that genomic sequence information (either reads or a sequence listing) for a prior normal sample may advantageously be utilized where available. Alternatively in some cases a reference genome (such as a reference human genome) may be utilized (for example where the region of investigation is relatively uniform in humans).

In certain embodiments that apply a Bayesian model to calling a genomic sequence, the probability of a hypothesis (proposed sequence values for the region of interest) being correct given the data (reads) is the normalized value of the probability of the hypothesis occurring (prior) times the probability of the data occurring given the hypothesis (model). In certain embodiments a Bayesian model is used to compare two genomes, a normal genome (for which the subscript n is used) and a cancer genome (for which the subscript c is used). Hypotheses can be generated for the pair Hₙ,H_{c} (i.e. hypotheses as to the sequences values for a region of interest for the normal and cancerous genome) and the evidence will be a pair Eₙ, E_{c} (i.e. the reads for the cancerous and normal sample in the region of interest, or simply the portions of the normal sequence where a sequence listing is available).

$$P ( {H}_{n} , {H}_{c} \vert {E}_{n} , {E}_{c} ) = \frac{P ( {E}_{n} , {E}_{c} \vert {H}_{n} , {H}_{c} ) \times P ( {H}_{n} , {H}_{c} )}{P ( E )} \qquad ( Equation 5 )$$

where P(E) is the cumulative value of the probability for all hypotheses to normalize the probability measure.

The “priors” (i.e. probability of a hypothesis occurring) may be obtained in a variety of ways. As outlined above P(Hn) may be obtained from, for example, a reference listing of the human genome, from a prior sequencing and/or from contemporaneous sequencing of the normal sample. P(H_{c}) may be obtained from, for example, reference listings of known cancer sequences. In certain embodiments P(H_{c}) is not a required term.

The hypotheses may be the reads for each sample.

Assuming no contamination:

P(Eₙ,E_{c}|Hₙ,H_{c})=P(Eₙ|Hₙ)P(E_{c}|H_{c})

That is, certain embodiments can use the posteriors (before applying priors) for the individual genomes from the calculations that are normally done for SNP (single-nucleotide polymorphism) calling. To compute the priors one can use a model where H_{c} is taken as being a mutation from an original normal hypothesis, and then:

P(Hₙ,H_{c})=P(Hₙ)Q(H_{c}|Hₙ)

where Q(H_{c}|Hₙ) is the probability of a transition from Hₙ to H_{c}. In certain embodiments this can be computed as a table given μ, the probability of a novel mutation on one of an homologous pair of chromosomes from the normal to cancer genome.

For example in the haploid case:

Q(C|A)=μ/3

Q(A|A)=1−μ

In the diploid case:

Q(XX|UV)=Q(X|U)Q(X|V)

Q(XY|UV)=Q(X|U)Q(Y|V)+Q(Y|U)Q(X|V) where X≠Y

In certain circumstances there is a non-zero probability that there will be an LOH (loss of heterozygosity) event on the cancer side. Sometimes it will be known from other analyses that this has happened and other times it can only be estimated as a general probability. Given LOH the calculation for Q is:

Q(XX|UV)=[Q(X|U)+Q(X|V)]/2

For complex calling, the individual transition Q(X|U) can be estimated using the technique described in U.S. Appl. 61/695,408 (which is hereby incorporated by reference) where the sequence X is matched against the sequence U and the transitions are normalized for a given U. It may be advantageous to include part of the reference on either side of the sequences to allow some correction when there are repeat or homopolymer regions.

Combining these formulae, we have:

$$\begin{matrix}P ( {H}_{n} , {H}_{c} \vert {E}_{n} , {E}_{c} ) = \frac{P ( {E}_{n} , {E}_{c} \vert {H}_{n} , {H}_{c} ) P ( {H}_{n} ) Q ( {H}_{c} , {H}_{n} )}{P ( E )} & ( Equation 6 ) \\ = \frac{P ( {E}_{n} \vert {H}_{n} ) P ( {E}_{c} \vert {H}_{c} ) P ( {H}_{n} ) Q ( {H}_{n} \vert {H}_{c} )}{P ( E )} & ( Equation 7 )\end{matrix}$$

To account for contamination of the cancer sample by normal DNA, the following modification can be included:

$$P ( {E}_{n} , {E}_{c} \vert {H}_{n} , {H}_{c} ) = P ( {E}_{n} \vert {H}_{n} ) P ( {E}_{c} \vert {H}_{n} , {H}_{c} )$$

$$P ( {E}_{n} , {H}_{n} ) = {\prod }_{{e}_{n} ∈ {E}_{n}} P ( {e}_{n} \vert {H}_{n} )$$

$$P ( {E}_{c} \vert {H}_{n} , {H}_{c} ) = {\prod }_{{e}_{c} ∈ {E}_{c}} P ( {e}_{c} \vert {H}_{n} , {H}_{c} )$$

and then assuming α is an estimate of the fraction of the cancer sample which is in fact normal tissue we have:

P(e_{c}|Hₙ,H_{c})=αP(e_{c}|Hₙ)+(1−α)P(e_{c}|H_{c}) (Equation 8)

The contamination value α may be determined by, for example:

(1) Expert determination by a clinician based on clinical factors and experience;

(2) Clinical information—using an appropriate formula, an expert system, neural network, learning system, or the like;

(3) Comparison of “SNP chips”—for example, compare the number of reads for an area of the sequence likely to give a good indication of relative proportions of normal and cancerous material;

(4) An optimization technique whereby a probability, for example the global probability, is maximized as the measure of goodness.

Combining the above this gives:

$$P ( {H}_{n} , {H}_{c} \vert {E}_{n} , {E}_{c} ) = \frac{P ( {E}_{n} \vert {H}_{n} ) P ( {E}_{c} \vert {H}_{n} , {H}_{c} ) P ( {H}_{n} ) Q ( {H}_{c} \vert {H}_{n} )}{P ( E )} \qquad ( Equation 9 )$$

In certain embodiments, P(E_{c}|Hₙ,H_{c}) is accumulated for all the pairs Hₙ,H_{c}, which imposes a significantly greater burden than computing P(Eₙ|Hₙ) and P(E_{c}|H_{c}) separately. One strategy that may be employed is to first compute without using contamination and then in cases where it seems that there may be a non-trivial case, to perform the full calculation.

### 1.4. Copy Number

In a tumor (and in other types of biological samples) the number of copies of a region may differ from that in the normal genome. This can be modeled by assuming that the total number of copies in the tumor is n and that the number of copies of one of an homologous pair of chromosomes is a and of the other is b, that is n=a+b. A special case that is of interest are regions of loss of heterozygosity. This occurs, for example, when the normal genome had a copy number of 2 and the tumor has a copy number of 1—that is, n=1 and a=1, b=0 (or vice versa).

When a≠b, a diploid hypothesis is no longer agnostic about orientation, that is the hypothesis AC differs from CA. To deal with this the tumor hypothesis H_{c} may be broken down into a pair H′_{c} and H″_{c} for each haploid hypothesis. For example, for simple SNP calls there can be 16 possible hypotheses rather than the normal 10. The set of hypotheses is given by H_{c}=H′_{c}×H″_{c}.

According to this embodiment, the formula that includes the effect of both contamination and copy number is:

$$P ( {e}_{c} \vert {H}_{n} , {H}_{c} ) = P ( {e}_{c} \vert {H}_{n} , {H}_{c}^{′} , {H}_{c}^{″} ) = α P ( {e}_{c} \vert {H}_{n} ) + ( 1 - α ) ( a / ( a + b ) P ( {e}_{c} \vert {H}_{c}^{′} ) + b / ( a + b ) P ( {e}_{c} \vert {H}_{c}^{″} ) ) \qquad ( equation 10 )$$

The copy number values a and b may be calculated in a variety of ways including:

(1) Based on the total number of reads associated with the normal biological sample and the number of reads associated with the cancerous biological sample;

(2) Based on the number of reads associated with the normal biological sample and the number of reads associated with the cancerous biological sample at a plurality of selected locations;

(3) Based on the number of reads associated with the normal biological sample and the number of reads associated with the cancerous biological sample at a location known to be particularly distinctive for one of the sequences.

It will be appreciated that the modification to accommodate copy number variation may be used independently of the modification for dealing with contamination and/or de novo mutations, as well as other aspects of the embodiments disclosed herein. The copy number variation techniques may be applied advantageously to better call cancer-related and other biological sequences irrespective of contamination.

Certain embodiments thus provide sequence calling methods using information for both normal and cancerous samples to provide high quality calls to be made with consistent scoring. The models can provide fast resolution of complex calling problems with improved accuracy. There is provided accurate calling of normal and cancerous sequences for mixed samples and methods of handling copy number variation.

### 1.5. Pruning

The probability of an hypothesis occurring (P(Hₘ), P(H_{f}) etc) may be based on historical sequence information, e.g., comparing the sequence in the area of interest with published sequence information (such as the 1000 Genomes Project or dbSNP) in the area of interest that is the probability of that sequence occurring, irrespective of the read data.

The possible hypotheses may include, for example:

(1) All possible sequences for the region of interest. This is generally the most processing intensive approach and may be most appropriate where deep investigation of a region is required or the sequence length is short.

(2) All read values occurring in the region of interest. It is unlikely that a sequence value not occurring in any read will be the correct value and so this approach limits computation without significant reduction in calling confidence.

(3) Read values above may be combined with “assemblies of reads”. Such “assemblies of reads” may combine “associated reads”. This association may be, for example, paired end reads or reads that are associated with external reference sequences (i.e. “pseudo reads” from publications or external events; not from “wet” reads from a sequencer). Such assembled reads may be combined across multiple samples.

The above hypotheses may be pruned using techniques including removing a hypothesis where, for example:

(1) the number of reads matching the hypothesis is below a threshold level;

(2) the occurrence of the hypothesis in historic data for the type of genomic sequence is below a threshold level; and/or

(3) the hypothesis breaches Mendelian inheritance rules.

In some situations pruning is not appropriate.

Hypotheses may also be evaluated in a prescribed order. This may be based on a weighting of hypotheses. The weighting of hypotheses may be a graduated scale or on a simple inclusion and exclusion basis. The weighting may be based upon the frequency of occurrence of a hypothesis in the sequence values and the hypotheses may be evaluated from the hypotheses having the highest weighting to those having the lowest weighting. Sex-based inheritance may also be taken into account. Evaluation may be terminated before all hypotheses are evaluated if an acceptance criterion is met. The acceptance criteria may be that a hypothesis is found to have a probability above a threshold value or be based on a trend in probabilities from evaluation (e.g. continually decreasing probabilities of hypotheses).

Model values (such as P(Dₘ|Hₘ) represent the probability of the genomic sequence information (e.g. (Dₘ) for a mother) occurring given the hypothesis (e.g. (Hₘ) for the mother). These model values may be calculated on the basis of one or more of:

(1) quality scores for sequencing machines (i.e. the figures as to sequencing accuracy published by sequencing machine manufacturers);

(2) calibrated quality scores (i.e. quality figures determined from preliminary alignment);

(3) mapping scores (such as MAPQ scores); and/or

(4) the chemistry of the sequences (there may be different probabilities of error, insertion, deletion, etc. depending upon the particular sequence values).

Hypotheses may be processed in an order considered most likely to produce a call meeting a required confidence level. Hypotheses may be rated according to factors such as their frequency of occurrence in the reads, a rating score (such as a MAPQ value) etc. Processing may be terminated if a hypothesis probability is above a threshold value or is trending in a desired manner. This is a technique to speed up processing and may not be appropriate where a more detailed evaluation is required.

Expectation maximization techniques may also be employed, as discussed above, to further refine calling. For example, priors may initially be based on sequence information for a known population. Family sequences may be called using the methodology described above. The family sequences may then be added to the priors and the family sequences recalled. This may be repeated until an acceptable convergence is achieved.

FIG. 2 illustrates a larger pedigree of six family members. In this case:

H=Hₘ×H_{f}×ΠHᵢ

P(H)=P(Hₘ,H_{f},ΠHᵢ)=P(Hₘ)×P(H_{f})×ΠM(Hᵢ|Hₘ,H_{f})

P(D|H)=P(Dₘ|Hₘ)×P(D_{f}|H_{f})×ΠP(Dᵢ|Hᵢ)

The resulting equation is:

$$P ( H \vert D ) = \frac{\begin{matrix}P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}{\begin{matrix}\sum P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}} \qquad ( Equation 11 )$$

where:
P(H|D) is the probability of a hypothesis (H) being correct for all members given all the genomic sequence information (D),
P(Hₘ)×P(H_{f}) is the probability of the hypotheses for the mother and father occurring based on historical information,
ΠM(Hᵢ|Hₘ,H_{f}) is the Mendelian probability of the hypotheses for the i children given the hypotheses for the parents,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (D_{f}) occurring for the hypothesis for the father (H_{f}),
Π(Dᵢ|Hᵢ) is the probability of the genomic sequence information for the i children occurring for the hypotheses for the children, and
ΣP(Hₘ)×P(H_{f})×ΠM(Hᵢ|Hₘ,H_{f})×P(Dₘ|Hₘ)×P(D_{f}|H_{f})×ΠP(Dᵢ|Hᵢ) is the sum of all probabilities for all hypotheses.

It can be seen that for a family with 2 parents and n children that processing will be of the order of 10²⁺ⁿ. For very large families this may require substantial processing capacity.

### 1.6. Application of Forward-Backward Algorithms

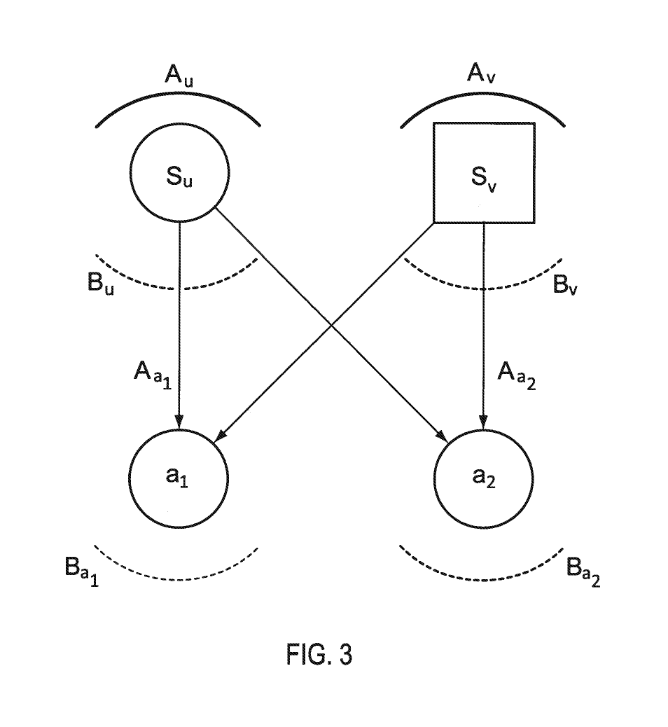

FIG. 3 illustrates a method of forward and backward propagation of values that is computationally more efficient for populations and large families. In certain embodiments of this process “A” values are calculated on the basis of the ancestors of each member (i.e. all members above a member in a generational representation). The A values are based on the members priors, the ancestor models above and Mendelian inheritance. These A values are propagated down to the generation below and affect the Priors for the generation below.

In certain embodiments, the “B” values are calculated on the basis of the Mendelian inheritance and the priors and models of the descendants below the member. The B values are propagated up to the generation above and affect the model for the parent.

In certain embodiments, the process may operate generally as follows:

(1) Calculate probabilities for each hypothesis for all members;
(2) Calculate A values and propagate these down to the generation below;
(3) Calculate B values and propagate these up to the generation above;
(4) Recalculate each hypothesis utilising each member's model and the propagated A and B values;
(5) Iterate forward and back through steps 2 to 4 until acceptable convergence is achieved. Acceptable convergence may be achieved when there is no further change during iterations or when an acceptable threshold has been met.

While for a single member just a single A value is propagated down, multiple B values may be propagated up and the recalculation will be based on the member's model, its A value, and all B values.

Where there is no genomic information for a population member, values may be inferred using this model. This enables the genomic sequences of population members to be called relatively accurately even where no or little genomic information is available.

### 1.7. Large Pedigrees

In certain embodiments, scores may be computed in a multi-genome variance caller to analyze genomic sequences corresponding to a large pedigree.

Large Pedigree Notation
a, b, c ranges over all children in a family
m, f index for mother and father respectively, in a family
u, v index for mother and father but leave unspecified which is which
h, i, j, k, l range over all possible hypotheses.
   j and k are paired respectively with u and v and f and m.
x range over all samples in pedigree.
A_{x,h} The “above” value for each sample.
B_{x,h} The “below” value for each sample (defined for monogamous families).
B_{x,y,h} The “below” value for each sample where y is the other parent.
B′_{x,y,h} Same as B_{x,y,h} but from the previous pass of the forward-backward algorithm.
S_{x,h}=The singleton posterior for each sample.

P(Dₓ|h)
M(h|j,k) Mendelian table (see multiScoring).
D Data for entire pedigree.
D_{X} Data for just the x'th sample.
H Hypotheses for entire pedigree.
H_{X} Hypotheses for just the x'th sample.
P(h) Prior.

### 1.8. Forward Backward Algorithm

Methods for approximating a Bayesian analysis for a large pedigree are included in the present disclosure.

In certain embodiments, a forward backward algorithm can be used to

approximate the Bayesian analysis:
compute singleton model for all samples (P(Hₓ|Dₓ))
initialize Aₓ to priors and Bₓ to identities
do

compute priors

recompute Aₓ forward through pedigree
(start with founders)

recompute Bₓ backward through pedigree
(start with latest descendants)

recompute calls for each sample (P(Eₓ\h)P(h))

until no change in calls
For founding parents, Aₓ is the prior computed at the start or on each iteration. For individuals with no children, Bₓ is an identity where B_{x,h}=1.

### 1.9. Monogamous Family

Certain embodiments involve computing Ax for the children and Bₓ for the parents in a single family embedded inside a pedigree (see, e.g., FIG. 3). This assumes that all parents are monogamous, that is, belong to only one family (two parents and one or more children).

Exemplary formulae are:

$${A}_{a , h} = {\sum }_{j} {A}_{u , j} {S}_{u , j} {\sum }_{k} {A}_{v , k} {S}_{v , k} M ( h \vert j , k ) {\prod }_{b \neq a} {\sum }_{l} M ( l \vert j , k ) {S}_{b , l} {B}_{b , l} \\ {B}_{u , j} = {\sum }_{k} {A}_{v , k} {S}_{v , k} {\prod }_{b} {\sum }_{l} M ( l \vert j , k ) {S}_{b , l} {B}_{b , l} \\ P ( {D}_{x} \vert h ) P ( h ) = {A}_{x , h} {S}_{x , h} {B}_{x , h} \\ where h = {H}_{x} \qquad ( Equation 12 )$$

### 1.10. Non-Monogamous Families

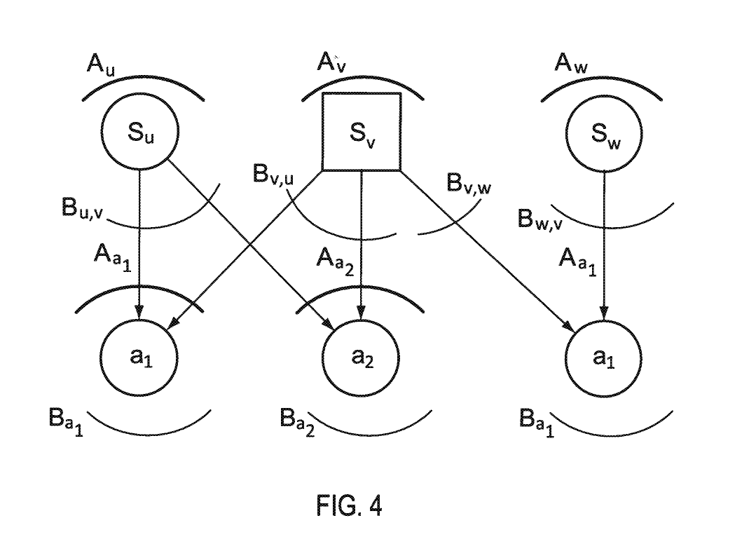

In certain embodiments, parents are not necessarily monogamous, that is, a parent can have children with more than one mate. See, e.g., FIG. 4.

Exemplary formulae are:

$${A}_{a , h} = {\sum }_{j} {A}_{u , j} {S}_{u , j} \{ {\prod }_{w \neq v} {B}_{u , w , j} \} {\sum }_{k} {A}_{v , k} {S}_{v , k} \{ {\prod }_{w \neq u} {B}_{v , w , k} \} \times M ( h \vert j , k ) {\prod }_{b \neq a} {\sum }_{l} M ( l \vert j , k ) {S}_{b , l} {\prod }_{w} {B}_{b , w , l} \\ {B}_{u , v , j} = {\sum }_{k} {A}_{v , k} {S}_{v , k} \{ {\prod }_{w \neq u} {B}_{v , w , k}^{′} \} {\prod }_{b} {\sum }_{l} M ( l \vert j , k ) {S}_{b , l} {\prod }_{w} {B}_{b , w , l} \\ P ( {E}_{x} \vert h ) P ( h ) = {A}_{x , h} {S}_{x , h} {\prod }_{w} {B}_{x , w , h} \\ where h = {H}_{x} . \qquad ( Equation 13 )$$

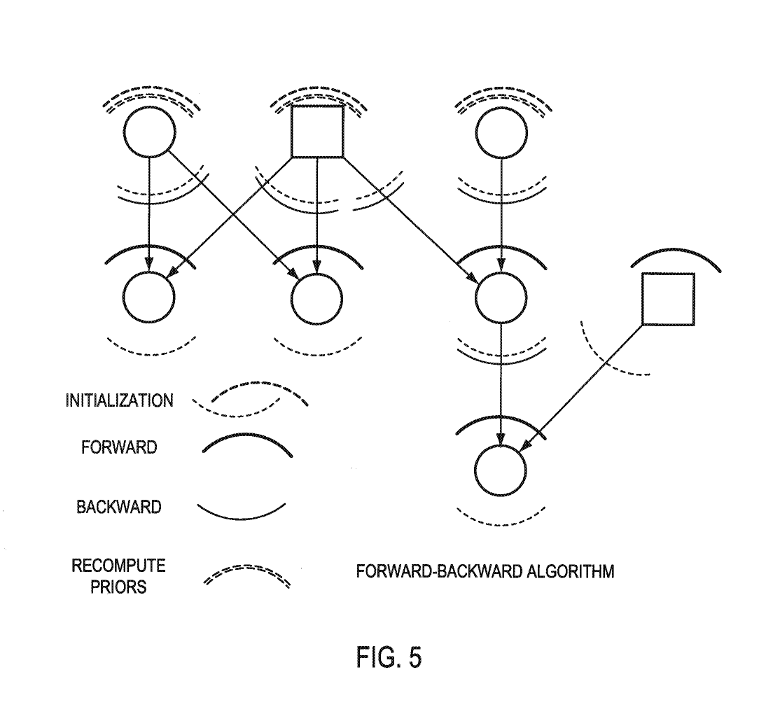

The order of execution can be straightforward in the forward direction. Execution order may be organized as a directed graph where there are directed arrows from each parent to its children. See, e.g., FIG. 5. This is guaranteed to be acyclic because conception is a causal operation. This is true for both monogamous and non-monogamous families.

The backward direction requires arrows from children to parents but also between half-siblings. The result is acyclic when the families are monogamous. However, in the presence of non-monogamous families it is possible to end up with cycles in the graph. One can ignore this and just use the most recent values of Bₓ at each step, unfortunately, the results depend on the order that nodes are visited. The solution above is to use the values of B from the previous generation (B′_{v,w,k}).

This approach can be computationally efficient for large families and provides improved calling for individuals with no or little coverage.

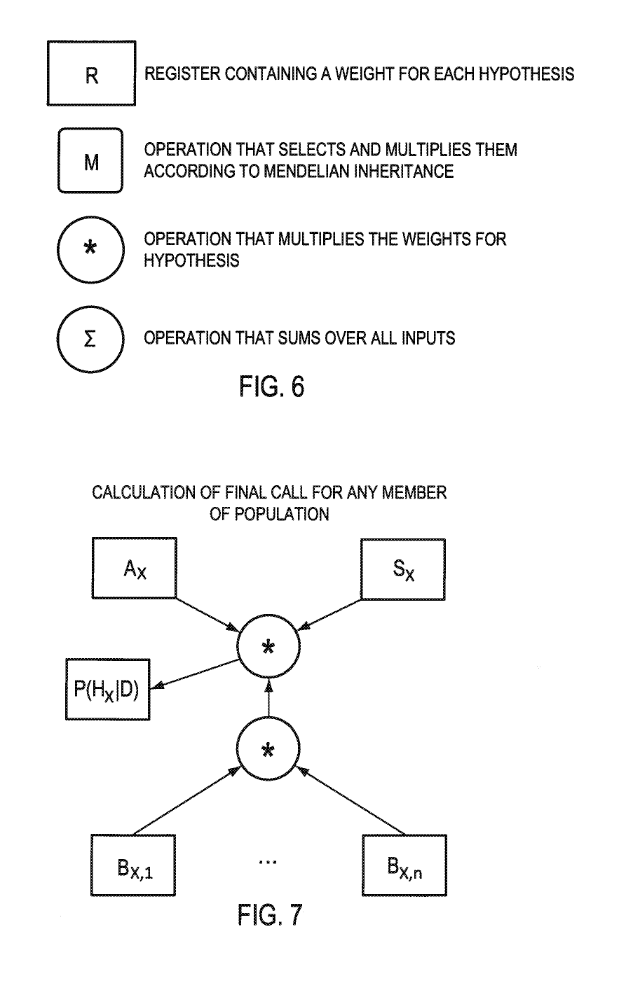

FIGS. 6-9 exemplify possible hardware implementation that may embody aspects of this method.

Exemplary hardware components are represented in FIG. 6, including registers that store one weight for each hypothesis, and computational units that multiply the weights of hypotheses, sum over weights and select weights according to the rules of Mendelian inheritance.

FIG. 7 shows the hardware components that can be used to compute the final normalized probabilities of the hypotheses (P(Hₓ|D)).

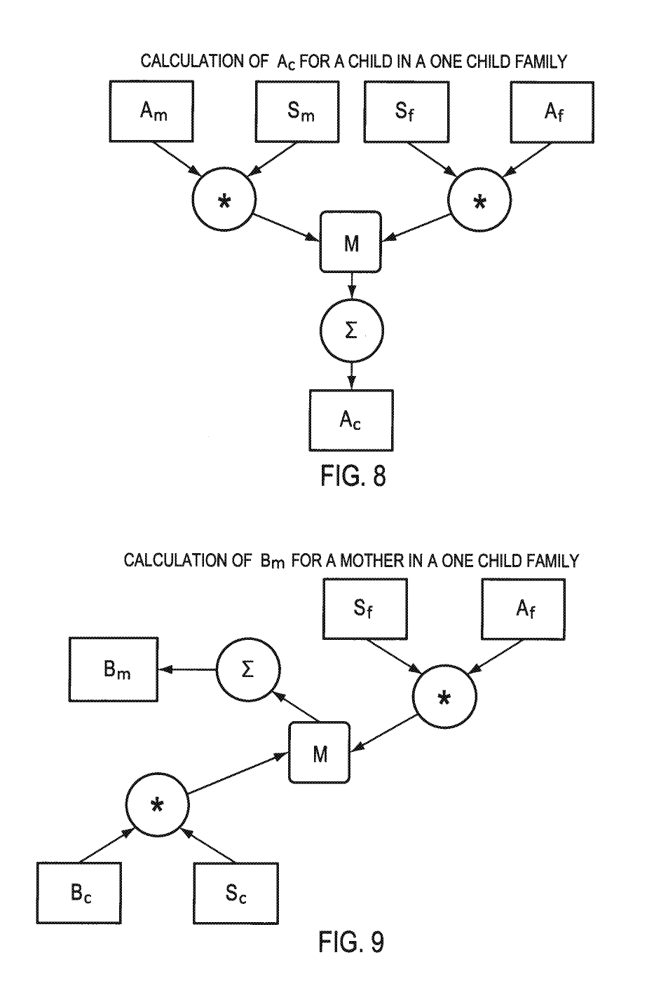

FIG. 8 shows the hardware that computes the A_{c} value for a child in a single child family. This example takes as inputs the A values and S values for the parents.

FIG. 9 shows the hardware that computes the Bₘ value for a mother in a single child family. This example takes as inputs the A values and S values for the father and the child.

Due to the large number of variant calling possibilities at each location in a genome, there may be benefit in using a specific hardware implementation utilizing parallel execution. Such hardware may dramatically increase the speed of the pedigree variant analysis.

In such a specific hardware solution a set of reads may be passed to the hardware device covering a fixed range across the genome. For example, given a window of, say 20, nucleotides across a chromosome, a set of reads that map to that location may be analyzed by the hardware device.

The pedigree information may also be provided with respect to each read. The hardware devices in parallel can update the thousands or hundreds of thousands of possible variants in parallel and a result obtained that maximizes a likelihood function.

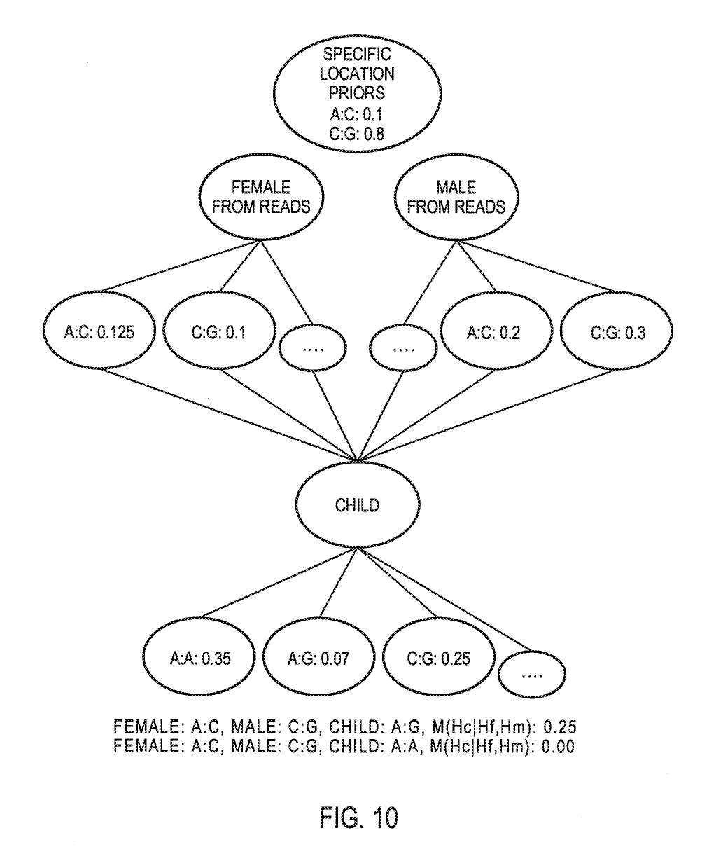

The possible variants can be designed as part of a neural network that efficiently updates counts and probabilities as more read-based evidence is supplied. An example representing a hardware device to provide real-time pedigree variant analysis is shown in FIG. 10.

As would be well understood by those of skill in the art, the disclosed methods may be performed by one or more processors executing program instructions stored on one or more memories. Certain embodiments comprise systems for calling genomic sequences, in which the system comprises one or more processors configured to execute one or more modules and a memory storing the one or more modules, wherein the modules comprise the exemplary hardware components disclosed above.

There are thus provided methods utilizing population and family information to provide high quality calls to be made with consistent scoring. The models provide a principled way of combining multiple effects with the ability to dynamically update model values as information increases. The models provide fast resolution of complex calling problems with improved accuracy.

### 2. JOINT CALLING OF BIOLOGICAL SEQUENCES

In certain embodiments, a Bayesian model can be applied to calling a biological sequence.

As used herein, “CPD” refers to a conditional probability distribution.

As used herein, a “read” may be a DNA sequence, an RNA sequence, a cDNA sequence, a protein sequence, or textual representations of such sequences. A read may be measured using an instrument or assay, such as, for example, a DNA sequencer, shotgun sequencing, or a next-generation sequencing method. Examples of next-generation sequencing methods include massively parallel signature sequencing, polony sequencing, 454 pyrosequencing, Solexa sequencing, SOLiD sequencing, and nanopore DNA sequencing. A read may also be obtained from literature values or public sequence databases such as EMBL, GenBank, and dbSNP.

As used herein, a “sample” may be any specimen from an organism that contains material that can be sequenced, e.g., extracted somatic tissue, gametes such as sperm, blood, or urine. A sample may comprise isolated DNA, RNA, chromosomes, or protein sequences. A sample may include bacteria or mitochondria. A sample may include cancerous tissue, noncancerous tissue, precancerous tissue, and/or tumor tissue.

As used herein, two sources of biological sequence are “genetically related” if one is descended from the other (e.g., grandparent to grandchild, or original and progeny cells, including but not limited to progeny cells bearing mutations relative to the original cells, e.g., cancerous cells which originated from originally noncancerous tissue) or if both can trace descent to a common source (e.g., cells descended from a common progenitor, siblings, or cousins).

As used herein, a “family” is a group of at least two individual organisms (family members) in which each individual organism in the family is a parent or child via sexual reproduction of at least one other individual organism in the family.

As used herein, sequence reads “correspond” to a source if the reads were generated by sequencing a physical sample taken from the source, or if they were generated computationally from a known, draft, or estimated sequence of the source (e.g., by simulating a sequencing methodology on the sequence to produce reads).

As used herein, the degree of relationship (DOR) between two sources is the minimum number of steps through lines of descent by which the sources are separated in a pedigree. Thus, for example, a parent and child have a DOR of one; siblings have a DOR of two; an aunt and niece have a DOR of three; and cousins have a DOR of four.

As used herein, a tissue or cell is pre-cancerous if it shows one or more pathological changes that may be preliminary to malignancy. Thus, a tissue or cell may be determined to be pre-cancerous based on, e.g., abnormal morphology, genetic mutations and/or gene expression patterns associated with carcinogenesis and not present in surrounding tissue, etc.

As used herein, “germ line” is used in a generic and relative sense to refer to cells or tissue of an original genotype from which another group of cells or tissue is descended, and is not limited to gametes and cells that develop into gametes. For example, healthy epithelial tissue would be considered germ line relative to a precancerous or cancerous growth within the epithelial tissue.

The notation used in this disclosure closely follows that used in “Probabilistic Graphical Models: Principles and Techniques”, Koller, D., Friedman, N., MIT Press, 2009.

In this disclosure, particular classes of random variables are referred to using the following notation:

Set-of-reads (S)—set of reads mapped to a particular locus (just the subset of nucleotides from the read that map to that locus).

Read (R)—the part of a single read mapped to a particular locus.

Copy Number (C)—the number of copies of each reference sequence.

Selection copies (B)—a vector of copy numbers detailing how children are generated from parents (e.g., it describes any mutations in copy number).

Haplotype (H)—a single sequence, usually a variant within a reference DNA sequence.

Genotype (G)—an ordered vector of the haplotypes at a particular locus (the number of them is determined by C and it is assumed that different orders of the haplotypes cannot be distinguished).

de novo (N)—binary indicator that a variant is a de novo mutation (that is, it is not present in its parents).

Local mutation (M)—vector of binary indicators that a mutation has occurred for a haplotype (used when analyzing mutation in diploid and more complex genotypes).

Contamination (A)—a real value between 0 and 1 that indicates the amount of contamination of one sample by another.

Disease (D)—binary value that says whether an individual has a trait or not (often the trait is a genetic disease).

Cause (U)—set of genotypes that is a putative cause of a disease.

The initial letters of the random variables are often used in diagrams and formulas (S, R, C, B, H, G, N, M, A, D, U). Lower case letters are used for particular values (s, r, c, b, h, g, n, m, a, d, u).

X, Y, and Z are used to denote generic random variables, and x, y, and z are used to denote values of generic random variables.

Bold upper case letters (e.g., X) are used to indicate sets of random variables, and x for the corresponding sets of values. The set of all random variables is given by x. Upper case versions of the particular type of random variables will indicate all instances of that type (e.g. G will be used for the set of all genotype random variables).

The standard definition of Bayes' formula is:

$$P ( X \vert Y ) = \frac{P ( Y \vert X ) P ( X )}{P ( Y )}$$

This can be derived from the identity

P(X|Y)P(Y)=P(Y|X)P(X)=P(X,Y)

Additionally,

P(Y)=ΣₓP(Y|x)P(x)=ΣₓP(Y,x)

In most cases below the disclosure provides an expression for the term

P(χ)=P(X|Y)P(Y)=P(Y|X)P(X)

where

χ=X [symbol] Y

Such an expression combined with the equations above can be used to compute various answers of the form P(X|Y).

In certain embodiments, given sets of reads (S) for a set of samples, the goal is to find the genotypes (G) for one or more of those samples. However, this is not the only information that we may want to extract. For example, it may be of interest to know the copy numbers (C), whether a mutation has occurred (N), and/or details of mutations (B,M) for use in other tools or to aid human understanding of what is happening.

### 2.1. Singleton Calling

In certain embodiments, one can infer the genotype from the supplied reads and/or can infer the copy number from the reads (for example, it may be possible to get an accurate estimate of the copy number even if the genotypes are not exactly known). To evaluate these inferences, the CPDs P(G|s) and P(C|s) can be computed.

The CPDs can be computed from the expression

P(χ)=P(S|G)P(G)

using Bayes formula where:

P(G) is the prior for the genotypes which is estimated from population studies of biological samples and from other theoretical information about mutation rates;

P(S|G) is the CPD for the reads in the sample given the genotypes—this will be described further below.

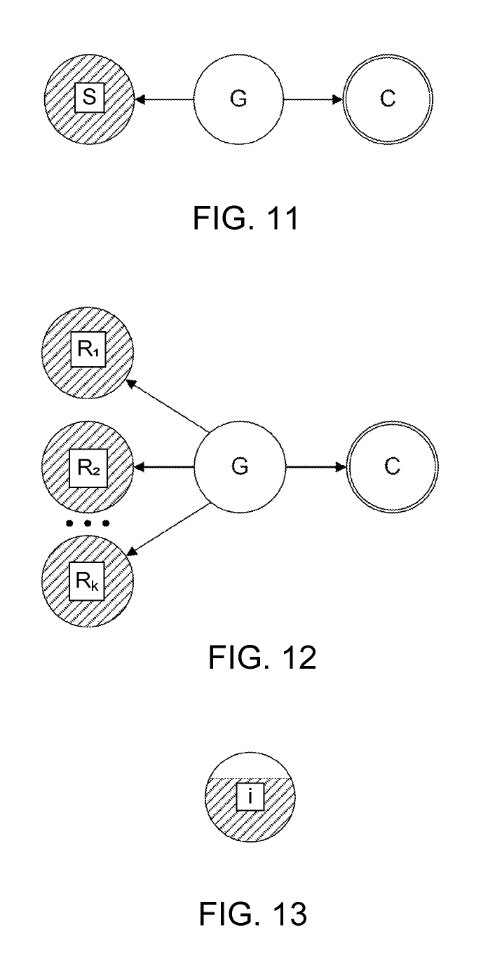

The diagram in FIG. 11 shows a Bayesian Network for this situation. The shaded circle surrounding S shows the random variable that can be supplied as observations. The double circle around the copy number C indicates that it can be computed deterministically from G (e.g., it can be computed as the length of the vector associated with G).

The copy number at a particular location can be influenced both by the biology of the situation and by mutations; for example, by sections of a genome that have been deleted or duplicated.

Possible interesting biological cases include: C=2 for eukaryotic autosomes; C=1 for haploid sequences in bacteria, sperm, mitochondria and sex chromosomes. For example, in humans both the X and Y chromosomes for males are haploid. In cancer C values can vary greatly from 0 for deleted regions to 5 or more for repeatedly duplicated regions. Thus in many cases C can have a fixed value known a priori (often 1 or 2). In other cases such as with cancerous tissue, it may sometimes be inferred from the sample.

P(S|G) can be computed using the following relationship:

P(s|G)=Π_{rϵs}P(r|G)

That is, the probability of the set of reads can be taken to be the product of the probability of each of the individual reads given the genotype. This assumes that the reads are independent of each other.

An expanded Bayesian Network representation for this situation is as follows. The disclosure will typically not use this expanded representation, leaving it as understood that when we use S it represents a set of reads as shown in FIG. 12.

We can provide P(R|G) to complete this analysis as follows.

Let g= [symbol] h₁, h₂, . . . , h_{c} [symbol] where c is the copy number. Then:

$$P ( R \vert g ) = \frac{{\sum }_{i} P ( R \vert {h}_{i} )}{c}$$

For example, consider the situation where the haplotypes can range over the individual values “A,C,G,T”, and then

$$P ( r \vert 〈 A , T 〉 ) = \frac{P ( r \vert A ) + P ( r \vert T )}{2}$$

That is, in this embodiment, the probability of an heterozygous diploid genotype is the average of the probability of its two constituent haplotypes.

The probability of an individual read, assuming a single haplotype, P(R|H), can often be computed using a table such as the one below:

TABLE 1

| | P(r\|h) |
|---|---|
| r = h | 1 − ϵ |
| r ≠ h | $\frac{ϵ}{( c - 1 )}$ |

where ϵ is the probability that the sequencing machine will make an error (and c is the copy number). More complex tables can be provided where, for example, the probability of an error depends on the neighboring nucleotides in the read or the reference.

FIG. 13 shows an abbreviation that will sometimes be used when illustrating certain embodiments, such as those involving large Bayesian networks such as pedigrees. It can be used to indicate this common combined network including S (or R), G and C and later also N, B, M. In certain embodiments, only an integer label rather than a random variable is included to indicate which sample it is taken from.

### 2.1.1. Incorrect Mapping

In some embodiments, the equations above are modified to allow for the possibility that a read has been mapped incorrectly to a locus. For example:

P′(R|G)=(1−η)P(R|G)+ηP(R)

where η is the probability that the read is incorrectly mapped and P′(R|G) is the modified version of P(R|G).

### 2.2. Single Parent Descent

In some embodiments, situations where there is a single parent leading to one or more descendants are analyzed. These situations are generalized to a linear sequence of such parent child relationships and then to pedigrees (branching trees). These cases can occur when dealing with, e.g., prokaryotes, cancer lineages and derived cell lines.

### 2.2.1. Simple Descent

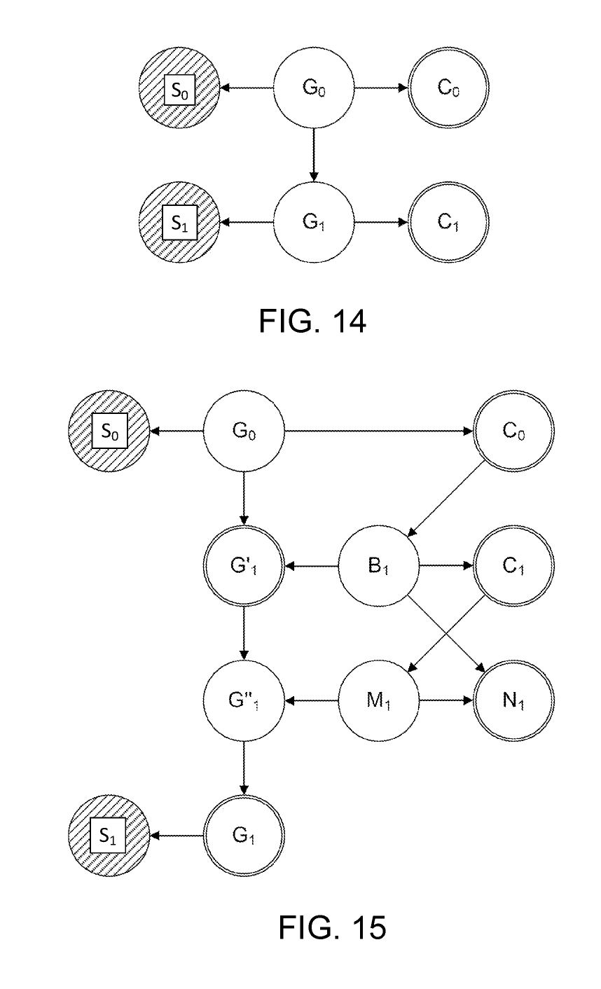

In some embodiments, one sample is known to be descended from a single other sample, and there is a possibility of mutation of both the copy number and of the genotype. See, e.g., FIG. 14. This covers situations such as the descent of a cancer cell from the germ line, a parent and daughter prokaryote or a single step in a derived cell line. The cancer case is dealt with in more detail later where issues such as contamination of the tumor sample by the germ line are covered.

As in the singleton case, it may be of primary interest to infer the genotypes of the parent and child. However other details such as the copy number and details of any mutations may be of interest independently of or in addition to the foregoing. With respect to parent and child genotypes, the inferences from the Bayesian network above include P(G₀|s), P(G₁|s), P(C₀|s), and P(C₁|s).

These can be computed from

P(χ)=P(s₁|G₁)P(G₁|G₀)P(s₀|G₀)P(G₀)

In what follows factors ψᵢ will be used to isolate the contributions local to a node i and its immediate parent or parents.

ψ₀(G₀)≡P(s₀|G₀)P(G₀)

ψ₁(G₀,G₁)≡P(s₁|G₁)P(G₁|G₀)

then P(χ) can be written as

P(χ)=ψ₀(G₀)ψ₁(G₀,G₁)

As an example, P(G₀|s) can be inferred as follows. First compute

$$P ( {G}_{0} , s ) = {\sum }_{{G}_{1}} P ( χ ) = {\sum }_{{G}_{1}} P ( {s}_{1} \vert {G}_{1} ) P ( {G}_{1} \vert {G}_{0} ) P ( {s}_{0} \vert {G}_{0} ) P ( {G}_{0} )$$

Then using Bayes formula we normalize the values in P(G₀, s) to give P(G₀|s):

$$P ( {G}_{0} \vert s ) = \frac{P ( {G}_{0} , s )}{{\sum }_{{G}_{0}} P ( {G}_{0} , s )}$$

P(C₀|s) can be inferred similarly. First compute

$$P ( {c}_{0} , s ) = {\sum }_{{G}_{0}} {\sum }_{{G}_{1}} P ( χ ) whenever {c}_{0} = \vert {G}_{0} \vert = {\sum }_{{G}_{0}} {\sum }_{{G}_{1}} P ( {s}_{1} \vert {G}_{1} ) P ( {G}_{1} \vert {G}_{0} ) P ( {s}_{0} \vert {G}_{0} ) P ( {G}_{0} ) whenever {c}_{0} = \vert {G}_{0} \vert$$

Then using Bayes formula we normalize the values in P(C₀, s) to give P(C₀|s):

$$P ( {C}_{0} \vert s ) = \frac{P ( {C}_{0} , s )}{{\sum }_{{G}_{0}} P ( {C}_{0} , s )}$$

P(G₁|s) and P(C₁|s) are computed similarly.

P(G₁|G₀) is the CPD for the child's genotype given the parent. In the absence of mutation this is deterministic (G₁ is equal to G₀). In the presence of mutation P(G₁|G₀) could be treated as a black box, however, this does little to explain its biological relevance and also makes it impossible to infer more detailed information such as whether a mutation has actually occurred or not. The Bayesian network shown in FIG. 15 shows the additional random variables and their relationships introduced to allow inference of more detailed information.

This diagram computes G₁ in two steps. First a vector B₁ is generated that describes any mutations in copy number and how to extract this from G₀. The result of the generation is recorded as a temporary genotype G′₁. This genotype may not be of interest, such that extraction of its probability distribution for the user is not necessarily performed.

Second a vector of mutation flags M₁ is generated and used to modify G′₁ to the temporary genotype G″₁. Again, this genotype may not be of interest, such that extraction of its probability distribution for the user is not necessarily performed. The items in the vector G″₁ are sorted, if necessary according to some consistent ordering to give the target genotype G₁. N₁ is true if any of the flags in M₁ are true or if any of the counts in B₁ differ from 1. C₁ can be computed deterministically from B₁ or the lengths of any of G′₁, G″₁, G₁.

If these new random variables are not to be explicitly inferred then P(χ) remains unchanged and P(G₁|G₀) can be computed from the formula

P(G₁|G₀)=Σ_{B}_{₁}Σ_{M}_{₁}P(G″₁|M₁,G′₁)P(M₁|C₁)P(B₁|C₀)

whenever

C₀=|G₀|,C₁=|G′₁|,G′₁=rep(G₀,B₁),N₁=or(B₁,M₁),G₁=sorted(G″₁)

If the new random variables are to be inferred then let

χ′=χ∪{G′₁,G″₁,B₁,M₁,C₀,C₁,N₁}

and

P(χ′)=P(s₁|G₁)P(G″₁|M₁,G′₁)P(M₁|C₁P(B₁|C₀)P(s₀|G₀)P(G₀)

The new random variables G′₁, G″₁, B₁, M₁, C₀, C₁, N₁ are now described in detail.

B₁ is a vector of (non-negative) integers whose length is specified by c₀. Each integer specifies the number of copies to take of the corresponding allele in G₀. Thus the sum of the integers in B₁ specifies the length of G₁, that is:

if B₁= [symbol] b₁,b₂, . . . ,b_{c}_{₀} [symbol] then

c₁=Σⱼ₌₁^{c}^{₀}bⱼ

If G₀= [symbol] h₁, h₂, . . . , h_{c}_{₀} [symbol] then the function rep(G₀, B₁) can take each haplotype hⱼ and replicates it bⱼ times giving a new vector of length c₁ (because G₀ is already sorted this result is also sorted). For example if G₀= [symbol] A,C,G,T [symbol] and B₁= [symbol] 1,0,2,0 [symbol] then s(G₀, B₁)= [symbol] A,G,G [symbol] .

In some embodiments, B₁ is by default a vector of all 1s (that is there is no change in copy number). In eukaryotic cell lines where c₀=2 then B₁= [symbol] 2,0 [symbol] or B₁= [symbol] 0,2 [symbol] might correspond to a gene conversion event where one haplotype has been replaced by the other giving two copies. P(B₁|C₀) will be determined by knowledge of the rates of copy number changes and gene conversions and similar phenomena in biological populations. In some embodiments, e.g., cancer, and/or where one or more DNA repair systems are not fully functional, such events can be relatively much more likely than in germ line or otherwise normal cells.

M₁ is a vector of true/false values of length c₁. Each true value indicates that the corresponding haplotype in G′₁ should be mutated. In some embodiments, the CPD P(M|C) is specified by assuming that there is an underlying rate of haploid mutations μ which sets the value for each item in M independently, that is, if

M= [symbol] m₁,m₂, . . . ,m_{c} [symbol] then:

P(M|c)=Πⱼ₌₁^{c}P(mⱼ)

where P(mⱼ=true)=μ and P(mⱼ=false)=1−μ. Alternatively, it can be assumed that at most one of the mⱼ can be true, in which case each of these unit vectors is given a probability of μ and the all false vector is given a probability of 1−cμ. This approach relies on μ being much less than 1, such that the cases where there is more than one mutation can be safely ignored.

P(G″₁|M₁,G′₁) gives the CPD by mutating each allele in G′₁ independently. Thus if G′₁= [symbol] h′₁, h′₂, . . . , h′_{c}_{₁} [symbol] , G″₁= [symbol] h″₁, h″₂, . . . , h″_{c}_{₁} [symbol] , and M₁= [symbol] m₁, m₂, . . . , m_{c}_{₁}

[symbol]

P(g″₁|m₁,g′₁)=Πⱼ₌₁^{c}^{₁}P(h″ⱼ|mⱼ,h′₁)

where P(h″ⱼ|mⱼ, h′ⱼ) is given by the following table. l is the number of different possible haplotypes (4 for ordinary SNPs but larger in more complex situations).

TABLE 2

| | m | P(h″\|m, h′) |
|---|---|---|
| h′ = h″ | true | 0 |
| h′ ≠ h″ | true | $\frac{1}{l - 1}$ |
| h′ = h″ | false | 1 |
| h′ ≠ h″ | false | 0 |

### 2.2.2. Examples of Single Descent Situations

The general technique discussed above can be illustrated with a number of biological examples.

In eukaryotic cell lines the most common case is that of an autosome where C₀=C₁=2 (ignoring any copy number variations).

The case where C₀=C₁=1 represents, amongst many possibilities:

one prokaryote descended from another,
a mitochondrion descended from a mother's mitochondrion.
the Y chromosome where sample 0 is a male mammal and sample 1 is his son.
the Y chromosome where sample 0 is a male mammal and sample 1 a sperm.
the W chromosome where sample 0 is a female bird and sample 1 is a female offspring.

The case where C₀=2 and C₁=1 represents, amongst many possibilities:

X chromosome where sample 0 is a female mammal and sample 1 is a male child.
Autosome where sample 0 is a male and sample 1 is a sperm.
Autosome where sample 0 is a female and sample 1 is a hydatiform mole.
Z chromosomes where sample 0 is a male and sample 1 is a female offspring among birds and other non-mammalian species.

In each of these cases the two most likely values for B₁ are [symbol] 1,0 [symbol] and [symbol] 0,1 [symbol] . That is, ignoring any mutations,

$$P ( 〈 1 , 0 〉 \vert 2 ) = P ( 〈 0 , 1 〉 \vert 2 ) = \frac{1}{2}$$

### 2.3. Multiple Descent

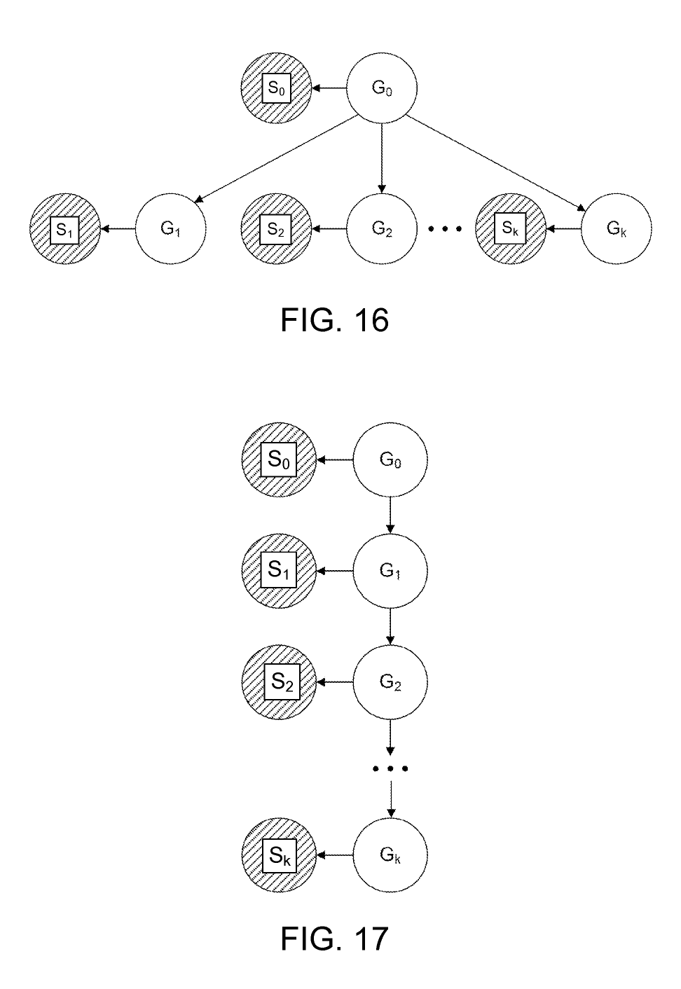

The analysis of the last section is now extended to include multiple descendants, as illustrated by the Bayesian network shown in FIG. 16.

This diagram can be applied to the cases mentioned above of cell lines, bacteria and cancer. It also describes the situation for identical twins (or triplets or higher multiplets) when S₀ will be empty (it corresponds to the zygote before splitting into identical twins and any subsequent de novo mutations).

As above P(Gᵢ|s) can be computed from:

P(χ)=P(s₀|G₀)P(G₀)P(G₀)Πᵢ₌₁^{k}P(sᵢ|Gᵢ)P(Gᵢ|G₀)

Refactoring in terms of ψ gives

ψ₀(G₀)≡P(s₀|G₀)P(G₀)

ψᵢ(G₀,Gᵢ)≡P(sᵢ|Gᵢ)P(Gᵢ|G₀) i≥1

then

P(χ)=ψ₀(G₀)Π_{i≥1}ψᵢ(G₀,Gᵢ)

The details at each of the random variables B, C, M, N have been omitted. They are local to each node and can be added back in systematically by expanding P(Gᵢ|G₀). Then P(χ) can be used to infer their values.

### 2.3.1. Series

The analysis of the preceding section is now extended to include a sequence of multiple descendants, giving the Bayesian network shown in FIG. 17.

P(Gᵢ|s) can be inferred from:

P(χ)=P(s₀|G₀)P(G₀)Πᵢ₌₁^{k}P(sᵢ|Gᵢ)P(Gᵢ|Gᵢ₋₁)

Refactoring in terms of ψ gives

ψ₀(G₀)≡P(s₀|G₀)P(G₀)

ψᵢ(G₀,Gᵢ)≡P(sᵢ|Gᵢ)P(Gᵢ|Gᵢ₋₁) i≥1

then

P(χ)=ψ₀(G₀)Π_{2≥1}ψᵢ(Gᵢ₋₁,Gᵢ)

This expression completely defines the problem. However, a plurality or all of the different inferences may be computed efficiently by using Forward-Backward variable elimination (also known as Belief Propagation) (Koller et al., Chapter 9).

The expression P(χ) which encapsulates the full Bayesian Network has in each case been defined as the product of the various ψᵢ factors. Although the details of how each of these is defined and which random variables they take as arguments may vary from sample to sample they can still be combined into one product for the whole pedigree. So in schematic form

P(χ)=Πᵢψᵢ

### 2.3.2. Pedigree With Multiple Descent

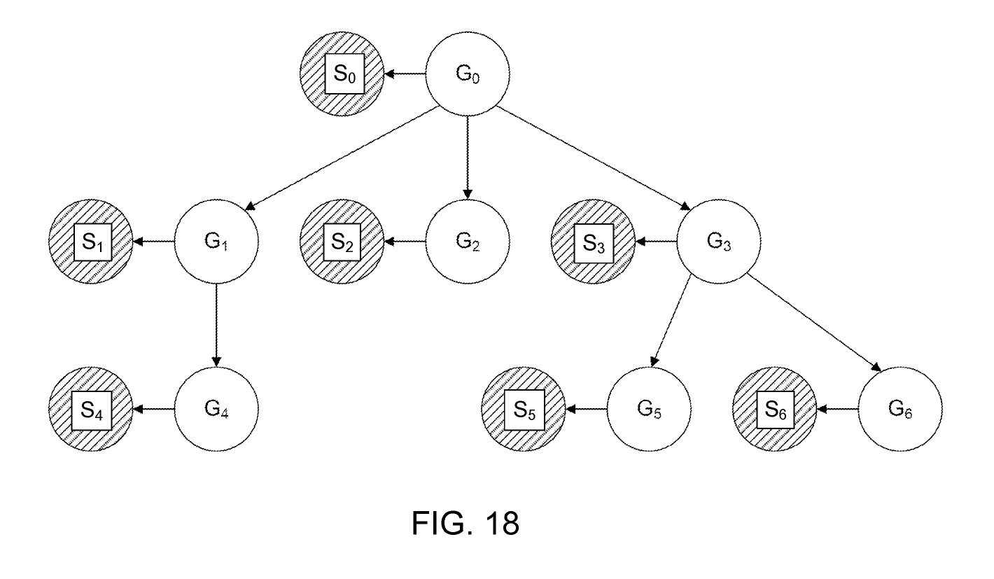

Combining the circumstances of branching and series allows forming a Bayesian Network in the form of a tree as exemplified in FIG. 18.

A general way of expressing the parents and children of a sample i allows formulation of the various expressions in this most general case.

Let i^{↑} be the (unique) parent of node i (not defined for the root node 0).

i is a leaf if [symbol] j:j^{↑}=i.

Let i^{↓} be the set of children of i.

The siblings of i are defined by

sib(i)≡(i^{↑})^{↓}−{i}.

This gives

P(χ)=P(s₀|G₀)P(G₀)Πᵢ₌₁^{k}P(sᵢ|Gᵢ)P(Gᵢ|Gᵢ_{^{↑}})

Refactoring in terms of ψ:

ψ₀(G₀)≡P(s₀|G₀)P(G₀)

ψᵢ(Gᵢ_{^{↑}},Gᵢ)≡P(sᵢ|Gᵢ)P(Gᵢ|Gᵢ_{^{↑}}) i≥1

P(χ)=ψ₀(G₀)Π_{i≥1}χᵢ(Gᵢ_{^{↑}},Gᵢ)

### 2.4. Contamination

Consider now a situation where material from sample 0 is present in sample 1. This can be relevant for cancer where sample 0 is the normal cells and sample 1 is the tumor cells, which may contain an admixture of sample 0.

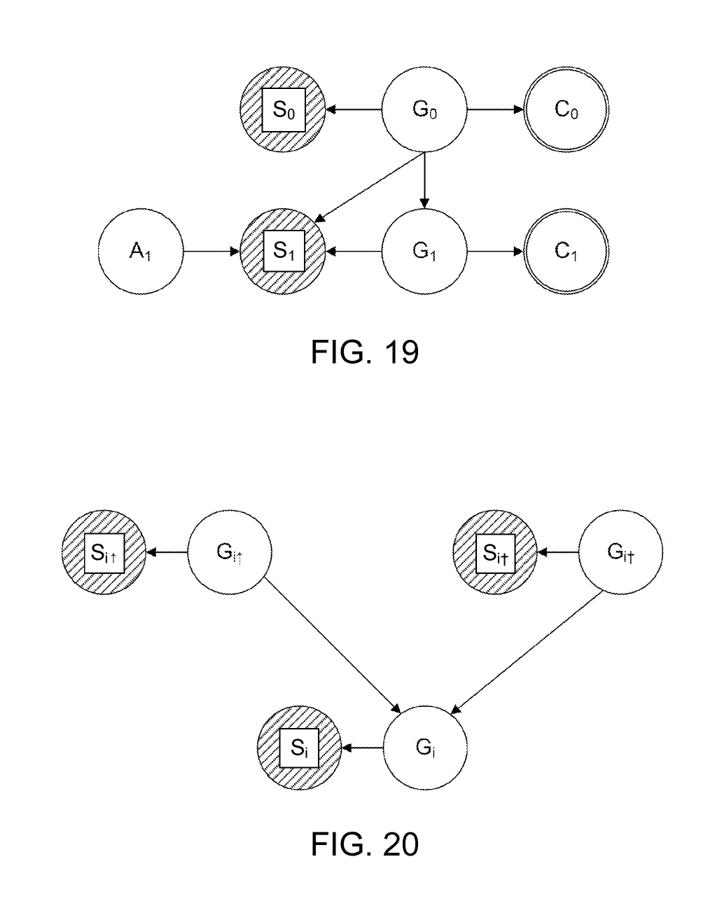

To model this a random variable A₁—the probability that material from sample 0 is present in sample 1—is introduced. See, e.g., FIG. 19. In the context of cancer A₁ is often referred to as cellularity. A specified value may be known for A₁, or it may be useful to provide a prior for A₁ and estimate it. Being a probability A₁ ranges continuously from 0 to 1. When it is eliminated in the various expressions below an integration is used rather than a sum.

As well as the usual inferences P(G₀|s), P(G₁|s), P(C₀|s), and P(C₁|s), P(A₁|s) may also be inferred, such as by using

P(χ)=P(S₁|G₁,G₀,A₁)P(G₁|G₀)P(A₁)P(s₀|G₀)P(G₀)

The new factor P(s₁|G₁, G₀,A₁) is defined by

P(s₁|G₁,G₀,A₁)=Πᵣ_{₁}_{ϵs}_{₁}P(r₁|G₁,G₀,A₁)

where the probability of an allele is the weighted sum of the probabilities in samples 0 and 1:

P(r₁|G₁,G₀,a₁)=a₁P(r₁|G₀)+(1−a₁)P(r₁|G₁)

Refactoring in terms of ψ gives

ψ₀(G₀)≡P(s₀|G₀)P(G₀)

ψ₁(G₀,G₁,A₁)≡P(S₁|G₁,G₀,A₁)P(G₁|G₀)P(A₁)

then P(χ) can be written as

P(χ)=ψ₀(G₀)ψ₁(G₀,G₁,A₁)

It is possible to extend this contamination scenario to a pedigree (and by implication a branching or series which are just special types of pedigrees). It is assumed that sample 0 is always the root of the pedigree and it is this sample that contaminates all the other samples. This fits a cancer scenario where there may be multiple copies of a tumor, some of which are descended from one another and all of which will be contaminated by normal tissue. There may also be other contamination situations (for example a sample being contaminated by two or more other samples) that can be formulated in a similar way.

The various factors need to be extended to include a reference to G₀ and to the various Aᵢ (each sample may be contaminated to a different degree) otherwise the computations are similar to the earlier pedigree without contamination.

ψ₀(G₀)≡P(s₀|G₀)P(G₀)

ψᵢ(G₀,Gᵢ,Aᵢ)≡P(sᵢ|Gᵢ,G₀,Aᵢ)P(Gᵢ|G₀) i^{↑}=0

ψᵢ(Gᵢ_{^{↑}},Gᵢ,G₀,Aᵢ)≡P(sᵢ|Gᵢ,G₀,Aᵢ)P(Gᵢ|Gᵢ_{^{↑}}) i^{↑}≠0

P(χ)=ψ₀(G₀)Πᵢ_{^{↑}}₌₀ψᵢ(G₀,Gᵢ,Aᵢ)Πᵢ_{^{↑}}_{≠0}ψᵢ(Gᵢ_{^{↑}},GᵢG₀,Aᵢ)

### 2.5. Parents

Above, the case where a sample has a single parent has been described. In this section the situation for a eukaryote resulting from sexual reproduction by two parents is developed.

Let i^{↑} be the (unique) father of node i and i^{†} be the (unique) mother of node i. i is a root if it has no father or mother. It is assumed that if one parent is present then the other is also. This can be achieved by adding a sample which contains no reads (S=Ø).

Let i^{↓} to be all the children of i, that is, i^{↓}={j:i=j^{↑}∨i=j^{†}}.

Let i [symbol] j be true (i and j are mated) if i and j have one or more children in common, that is,

i [symbol] j≡i^{↓}∩j^{↓}≠Ø∧i≠j

i is a leaf if it has no children, that is, i^{↓}=Ø

The (full) siblings of i are given by

sib(i)=(i^{↑})^{↓}∩(i^{†})^{↓}−{i}

FIG. 20 shows a Bayesian Network for a simple family with two parents and one child.

P(Gⱼ|s) can be computed from:

P(χ)=P(sᵢ_{^{↑}}|Gᵢ_{^{↑}})P(sᵢ_{^{†}}|Gᵢ_{^{†}})P(sᵢ|Gᵢ)P(Gᵢ|Gᵢ_{^{↑}},Gᵢ_{^{†}})P(Gᵢ_{^{↑}})P(Gᵢ_{^{†}})

Refactoring in terms of ψ gives

ψᵢ_{^{↑}}(Gᵢ_{^{↑}})=P(sᵢ_{^{↑}}|Gᵢ_{^{↑}})P(Gᵢ_{^{↑}})

ψᵢ_{^{†}}(Gᵢ_{^{†)=}}P(sᵢ_{^{\}}|Gᵢ_{^{†}})P(Gᵢ_{^{†}})

ψᵢ(Gᵢ,Gᵢ_{^{↑}},Gᵢ_{^{†}})=P(Gᵢ|Gᵢ_{^{i↑,G}}ᵢ_{^{↑}})P(sᵢ|Gᵢ)

then

P(χ)=ψᵢ(Gᵢ,Gᵢ_{^{↑}},Gᵢ_{^{†}})ψᵢ_{^{↑}}(Gᵢ_{^{↑}})ψᵢ_{^{†}}(Gᵢ_{^{†)}}

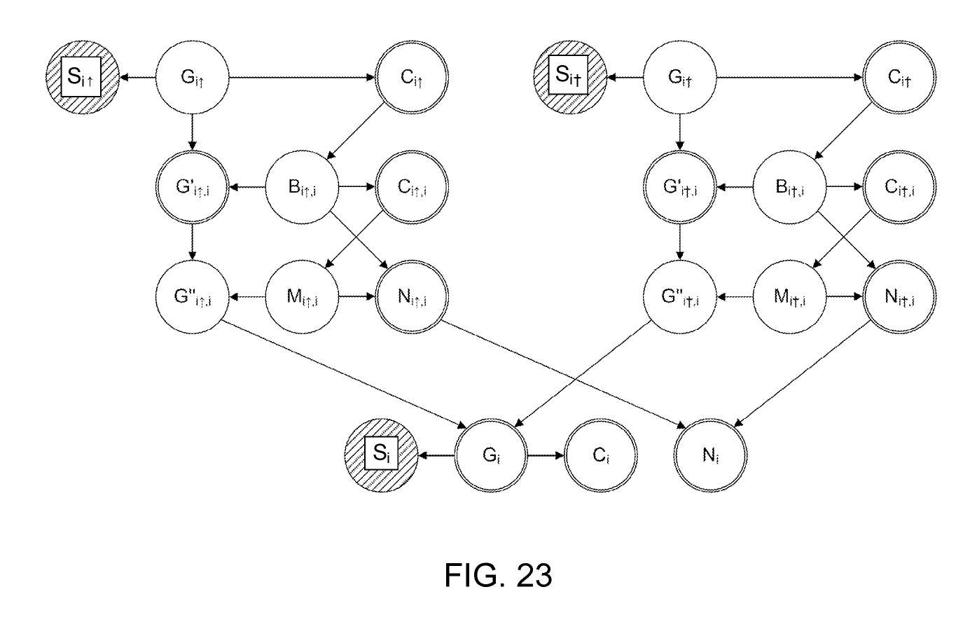

As in the single parent case P(Gᵢ|Gᵢ_{^{↑}},Gᵢ_{^{†}}) can be expanded to explicitly allow for copy number and genotype mutations. FIG. 23 illustrates a Bayesian network for this case.

The network used in the single parent case has been replicated twice, once for each parent. The calculations for each of the terms G′, G″, B, C, M, N can be performed in the same way as in the single parent case.

Two new deterministic calculations are included in this example. Gᵢ is deterministically computed from and G″ᵢ_{^{↑}}_{,i} and G″ᵢ_{^{†}}_{,i}. This is done by appending the two genotype vectors and sorting the result. Nᵢ is deterministically computed as the logical or of Nᵢ_{^{↑}}_{,i} and Nᵢ_{^{†}}_{,i}.

As shown in the single parent case the CPD P(Gᵢ|Gᵢ_{^{↑}},Gᵢ_{^{†}}) can be computed by summing over the B, M variables. If it is wished to infer any of the G′, G″, B, C, M, N then the expression P(χ) can be expanded to include them (the details of this have been omitted for conciseness).

This formulation can deal with the following cases amongst many others.

Sexually reproducing eukaryote autosomes have Cᵢ_{^{↑}}=Cᵢ_{^{†}}=Cᵢ=2 (including the pseudo-autosomal regions on human (eutherian) X and Y chromosomes). In this case the haplotypes are chosen randomly from each parent (ignoring mutations and other non-Mendelian mechanisms such as gene conversion or copy number changes). This is quantified by letting

$$P ( 〈 1 , 0 〉 \vert 2 ) = P ( 〈 0 , 1 〉 \vert 2 ) = \frac{1}{2} for P ( {B}_{{i}^{↑} , i} \vert {C}_{{i}^{↑} , i} ) and$$

$$P ( {B}_{{i}^{†} , i} \vert {C}_{{i}^{†} , i} ) .$$

For a human (eutherian) X chromosome when the child is female the copy numbers are

$${C}_{{i}^{↑}} = 1 , {C}_{{i}^{†}} = 2 , {C}_{i} = 2 then P ( {B}_{{i}^{↑} , i} = 〈 1 〉 \vert {C}_{{i}^{↑} , i} = 1 ) = 1 and$$

$$P ( {B}_{{i}^{†} , i} = 〈 1 , 0 〉 \vert {C}_{{i}^{†} , i} = 2 ) = P ( {B}_{{i}^{†} , i} = 〈 0 , 1 〉 \vert {C}_{{i}^{†} , i} = 2 ) = \frac{1}{2}$$

### 2.6. Family

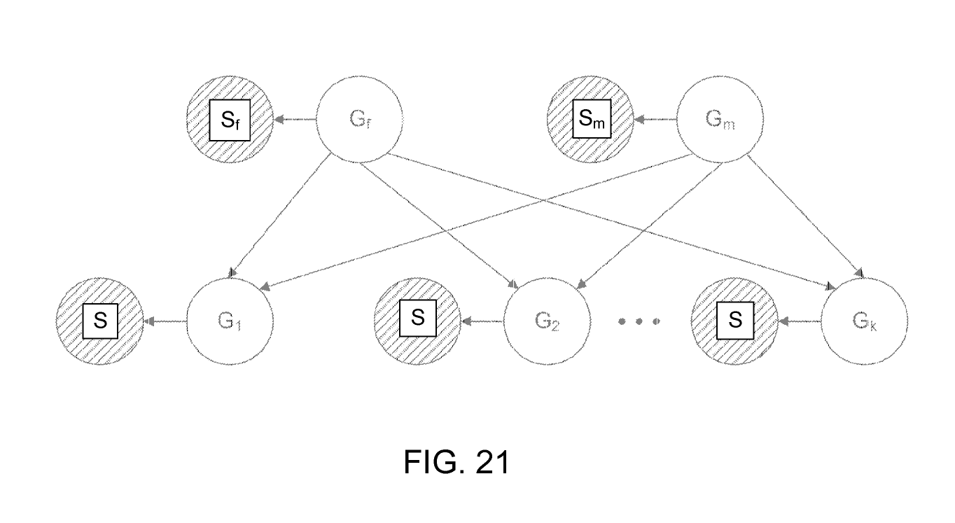

The Bayesian network in FIG. 21 illustrates the situation for two parents and multiple children.

P(Gⱼ|s) can be computed from:

P(χ)=P(s_{f}|G_{f})P(G_{f})P(sₘ|Gₘ)P(Gₘ)Πᵢ₌₁^{k}P(sᵢ|Gᵢ)P(Gᵢ|Gᵢ_{^{↑}},Gᵢ_{_{†}})

(note that i^{↑}=f and i^{†}=m for all the children).

Refactoring in terms of ψ gives

ψ_{f}(G_{f})=P(s_{f}|G_{f})P(G_{f})

ψₘ(Gₘ)=P(sₘ|Gₘ)P(Gₘ)

ψᵢ(Gᵢ,Gᵢ_{^{↑,}}Gᵢ_{^{†}})=P(Gᵢ|Gᵢ_{^{↑,}}Gᵢ_{^{†}})P(sᵢ|Gᵢ)

then

P(χ)=ψ_{f}(G_{f})ψₘ(Gₘ)Πᵢ₌₁^{k}ψᵢ(Gᵢ,Gᵢ_{^{↑}},Gᵢ_{_{†}})

### 2.6.1. Extended Pedigree

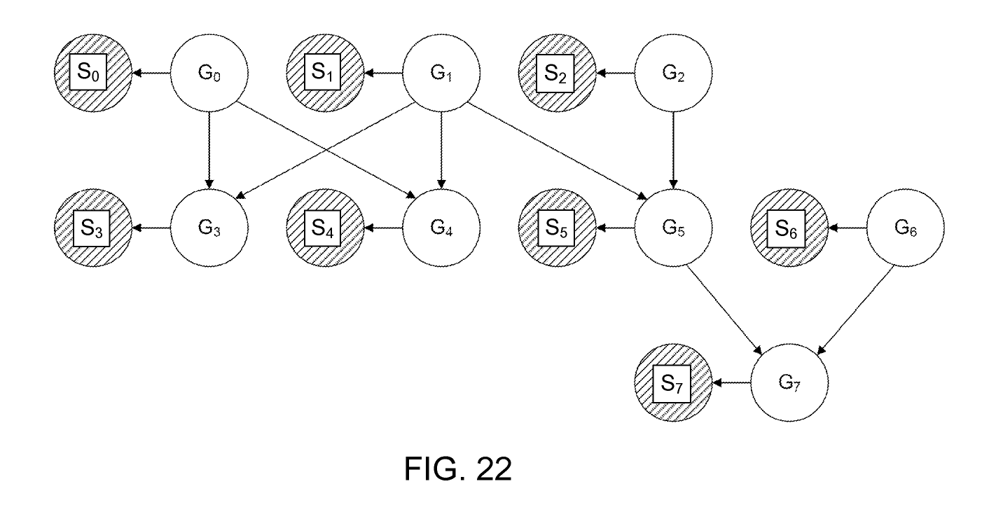

The example in FIG. 22 shows a Bayesian network for an extended pedigree with multiple generations.

As usual P(χ) will be defined in terms of ψᵢ where

ψᵢ(Gᵢ)=P(sᵢ|Gᵢ)P(Gᵢ) i is root

ψᵢ(Gᵢ,Gᵢ_{^{↑}},Gᵢ_{^{†}})=P(Gᵢ|Gᵢ_{^{↑,G}}ᵢ_{^{†}})P(sᵢ|Gᵢ) i not root

P(χ)=Π_{i is root}ψᵢ(Gᵢ)×Π_{i not root}ψᵢ(Gᵢ,Gᵢ_{^{↑}},Gᵢ_{^{†}})

Efficient calculation of the inferences in such an extended pedigree can be done with Belief Propagation if the pedigree is a polytree (there is at most one path between any two nodes in the network). When there is inbreeding and multiple paths, loopy Belief Propagation and convergence can be used.

### 2.7. Phenotypes

Consider a pedigree where the presence or absence of some phenotypic trait (D) is known for each sample. The values for D can be a disease, or any other trait caused by a single variant. It is desired to infer possible genetic explanations for this (U). Note that U has a single value across all samples (but will vary from locus to locus). This is useful because it can provide more accurate estimations of the reliability of a possible cause of a trait than working directly off called individual genotypes.

The range of U is all sets of genotypes that might explain the trait, including the empty set for when the locus is unable to explain the trait. For example, if a genotype is a diploid SNP with a dominant allele A then u={ [symbol] A,A [symbol] , [symbol] A,C [symbol] , [symbol] A,G [symbol] , [symbol] A,T [symbol] )}.

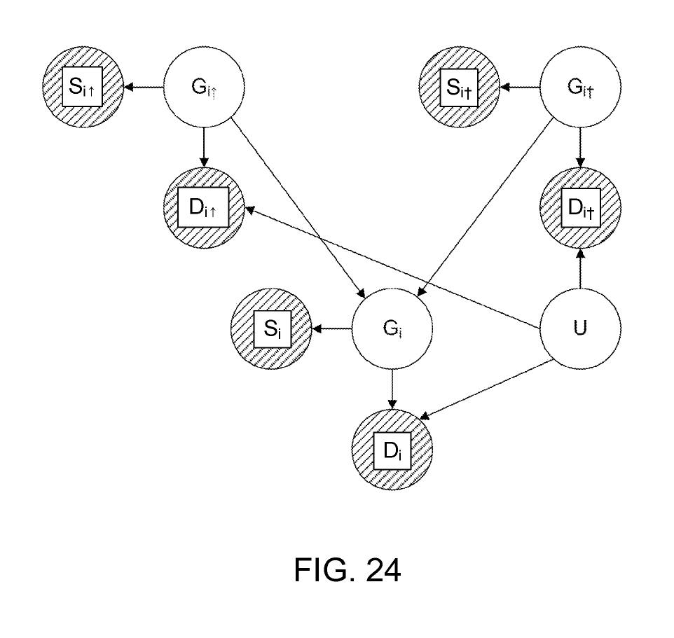

The Bayesian Network in FIG. 24 shows an example of a pedigree with two parents and one child including the traits (D) and the explanation U. The Dᵢ are shown shaded because they are usually known and they are also deterministically computed from Gᵢ and U.

Going directly to a full pedigree then P(χ) will be defined in terms of ψᵢ which now includes U as an argument. A prior P(U) is also included for the explanation.

ψᵢ(Gᵢ,U)=P(sᵢ|Gᵢ)P(Gᵢ) whenever Dᵢ=GᵢϵU and i is a root

ψᵢ(Gᵢ,Gᵢ_{^{↑}},Gᵢ_{^{†}},U)=P(Gᵢ|Gᵢ_{^{↑}},Gᵢ_{^{†}})P(sᵢ|Gᵢ) whenever Dᵢ=GᵢϵU and i is not a root

P(χ)=P(U)Π_{i is root}ψᵢ(Gᵢ)×Π_{i not root}ψᵢ(Gᵢ,Gᵢ_{^{↑}},Gᵢ_{^{†}})

The most important inferences include P(Gᵢ|s) and P(U|s,d).

The prior P(U) can encode a number of biological aspects. For example it may be known that the trait is recessive or dominant which can be encoded by altering which subsets in U have non-zero probabilities. Also the prior probabilities for alleles that are known to be of high prevalence in a population can be reduced for unusual traits such as rare diseases, for example by lowering the probabilities according to a down-weighting factor. The down-weighting factor could be determined, e.g., as a function of the ratio of the prevalence of the disease to the prevalence of the allele.

### 2.8. Combinations

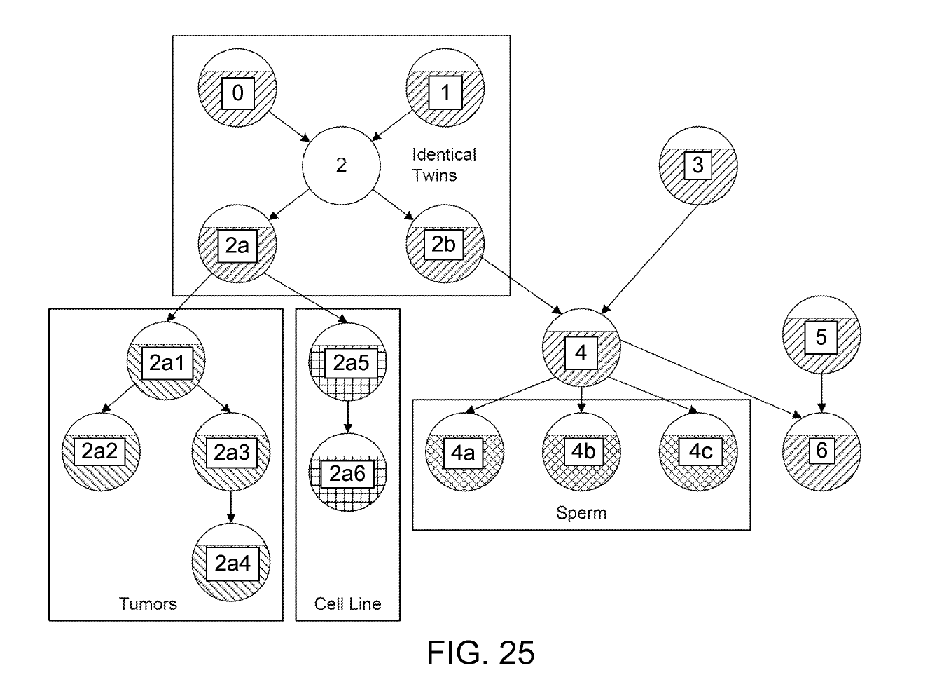

There are many biologically useful ways of combining these various different analyses. One example is given as a pedigree diagram in FIG. 25. This shows a family pedigree with various single descent lineages attached as well as a pair of identical twins in the middle.

Exemplary combinations include:
Cancer branching series descended from an individual within a family pedigree (see sample 2a1 and below).
Cell line branching series descended from an individual within a family pedigree (see sample 2a5 and below).
Multiple sperm samples branched from a single individual (see below 4).
Combinations of each of these branching series descended from the same individual (see 2a and below and 2b and below).
Identical twins in the middle of a pedigree (see sample 2 and samples 2a and 2b). Sample 2 is the hypothetical sequence of the conception before the two twins split. Thus 2a and 2b may contain de novo mutations not present in 2.

The general principle of how to combine these elements uses the expression P(χ) which encapsulates the full Bayesian Network. In each case this has been defined as the product of the various ψᵢ factors. The details of how each of these is defined and which random variables they take as arguments may vary from sample to sample. Nonetheless, they can still be combined into one product for the whole pedigree. So in generalized form,

P(χ)=Πᵢψᵢ(Gᵢ)

where Gᵢ is the genotype Gᵢ and its parents (if any).

This also works when the trait explanation U is included, yielding

P(χ)=P(U)Πᵢψᵢ(Gᵢ∪{U})

In certain embodiments, the entire genome of a biological sequence source is modelled. In certain embodiments, at least 80%, 90%, 95%, 99%, or 99.9% of the genome of a biological sequence source is modelled. In certain embodiments, at least 80%, 90%, 95%, 99%, 99.9%, or all protein-coding sequence in the genome of a biological sequence source is modelled. In certain embodiments, an entire chromosome, multiple chromosomes, or an amount of sequence equivalent to an entire chromosome or multiple chromosomes of a biological sequence source is modelled. In certain embodiments, a subset of a chromosome is modelled. In certain embodiments, the full length of the most likely or probable value for a modelled genomic sequence is provided. In certain embodiments, only a subset of the full length of the modelled genomic sequence is provided as a most likely or probable value. In certain embodiments, one value is provided for a modelled genomic sequence. In certain embodiments, two, three, five, or more than ten values are provided for a modelled genomic sequence. In certain embodiments, a complete genomic sequence or subset of a genomic sequence is modelled for one or more than one sources. Thus, a complete genomic sequence or subset of a genomic sequence may be modelled for one, two, three, four, five, or more family members, cell lines, tissue samples, specimens, etc.

In certain embodiments, some or all of the biological sequence read information from one or more of the sources used in methods according to this disclosure is estimated from extrinsic data. Data is extrinsic relative to a source to the extent that it includes any information other than sequence data from the source. Thus, examples of extrinsic data include reference sequence data from a database, sequence data from a different but genetically related source, and phenotypic (trait) data.

As would be well understood by those of skill in the art, the disclosed methods may be performed by one or more processors executing program instructions stored on one or more memories. Certain embodiments comprise systems for calling biological sequences, in which the system comprises one or more processors configured to execute one or more modules and a memory storing the one or more modules, wherein the modules comprise the exemplary hardware components disclosed above.

Other embodiments of the invention will be apparent to those skilled in the art from consideration of the specification and practice of the invention disclosed herein. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept. It is intended that the specification and examples be considered as exemplary only, with a true scope and spirit of the invention being indicated by the following claims.

### 3. EXAMPLES

The following specific examples are to be construed as merely illustrative, and not limiting of the disclosure.

### 3.1. Example 1: Bayesian Calling for Haploid Genome

Table 1 below provides an example illustrating the application of the invention to a haploid genome. Applying a Bayesian model to calling a genomic sequence the probability of a hypothesis (proposed sequence values for the region of interest) being correct given the data (reads) is the normalized value of the probability of the hypothesis occurring (prior) times the probability of the data occurring given the hypothesis (model) which may be expressed as described in Equation 1, repeated here:

$$P ( H \vert D ) = \frac{P ( H ) \times P ( D \vert H )}{\sum P ( H ) \times P ( D \vert H )} \qquad ( Equation 1 )$$

where:
P(H|D) is the probability of a hypothesis H being correct for all members given data D,
P(H) is the probability of the hypothesis occurring, independent of the data D,
P(D|H) the probability of the data D occurring given the hypothesis, and
ΣP(H)×P(D|H) is the sum of all probabilities for all hypotheses, which is used to normalize the results.

TABLE 3

| Hypotheses(H) (base) | A | C | G | T |
|---|---|---|---|---|
| P(H) | 0.700000 | 0.100000 | 0.100000 | 0.100000 |
| Evidence in Read (d) | | | | |
| P(d\|H) | | | | |
| A | 0.900000 | 0.033333 | 0.033333 | 0.033333 |
| C | 0.033333 | 0.900000 | 0.033333 | 0.033333 |
| G | 0.033333 | 0.033333 | 0.900000 | 0.033333 |
| P(D\|H) | 0.001000 | 0.001000 | 0.001000 | 0.000037 |
| P(D\|H)P(H) | 0.000700 | 0.000100 | 0.000100 | 0.000004 |
| Σ P(D\|H)P(H) | 0.00090 | | | |
| P(H\|D) | 0.774590 | 0.110656 | 0.110656 | 0.004098 |

### 3.2. Example 2: Bayesian Calling for a Family

Table 4 below provides an example illustrating the application of the invention to a family. Where a family is being evaluated, such as illustrated in FIG. 1, Mendelian inheritance information may be incorporated into the model. Applying Equation 2 to a nuclear family of a mother (m) a father (f) and a child (c), it becomes:

$$P ( H \vert D ) = \frac{\begin{matrix}P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}}{\begin{matrix}\sum P ( {D}_{m} \vert {H}_{m} ) \times P ( {D}_{f} \vert {H}_{f} ) \times \\ P ( {D}_{c} \vert {H}_{c} ) \times P ( {H}_{m} , {H}_{f} , {H}_{c} )\end{matrix}} \qquad ( Equation 3 )$$

which may be re-expressed as:

$$P ( H \vert D ) = \frac{\begin{matrix}P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}}{\begin{matrix}\sum P ( {D}_{m} \vert {H}_{m} ) \times P ( {D}_{f} \vert {H}_{f} ) \times P ( {D}_{c} \vert {H}_{c} ) \times \\ P ( {H}_{m} ) \times P ( {H}_{f} ) \times M ( {H}_{c} \vert {H}_{m} , {H}_{f} )\end{matrix}} \qquad ( Equation 4 )$$

where:
P(H|D) is the probability of a hypothesis (H) being correct for all members given data D,
P(Dₘ|Hₘ) is the probability of the genomic sequence information for a mother (Dₘ) occurring for the hypothesis for the mother (Hₘ),
P(D_{f}|H_{f}) is the probability of the genomic sequence information for a father (Df) occurring for the hypothesis for the father (H_{c}),
P(D_{c}|H_{c}) is the probability of the genomic sequence information for a child (Dc) occurring for the hypothesis for the child (H_{c}),
P(Hₘ) is the probability of the hypothesis occurring for the mother, independent of the data D,
P(H_{f}) is the probability of the hypothesis occurring for the father, independent of the data D,
M(H_{c}|Hₘ,H_{f}) is the Mendelian probability of the hypothesis for the child given the hypotheses for the parents, and
P(Dₘ|Hₘ)×P(D_{f}|H_{f})×P(D_{c}|H_{c}×P(Hₘ)×P(H_{f})×M(H_{c}|Hₘ×H_{f}) is the sum of all probabilities over all possible combinations of hypotheses for the parent and child used to normalize probabilities.

TABLE 5

| H | P(H) |
|---|---|
| A:C | 0.1 |
| C:G | 0.8 |

. . .

| Hf | Hm | Hc | M(HC\|Hf,Hm) |
|---|---|---|---|
| A:C | A:C | A:C | 0.50 |
| A:C | C:G | A:G | 0.25 |
| A:C | C:G | A:A | 0.00 |

. . .

| Father | | Mother | |
|---|---|---|---|
| Hf | P(Df\|Hf) | Hm | P(Dm\|Hm) |
| A:C | 0.125 | A:C | 0.2000 |
| C:G | 0.100 | C:G | 0.3000 |

. . .

| Child | |
|---|---|
| Hc | P(Dc\|Hc) |
| A:A | 0.350 |
| A:G | 0.007 |
| C:G | 0.250 |

. . .

| H | | | | | | |
|---|---|---|---|---|---|---|
| Hf | Hm | Hc | P(D\|H) | P(Hf)P(Hm) | M(Hc\|Hf,Hm) | P(D\|H)P(H) |
| A:C | C:G | A:G | 0.000263 | 0.080000 | 0.250000 | 0.00000525 |
| A:C | C:G | A:A | 0.013125 | 0.080000 | 0.000000 | 0.00000000 |

### 3.3. Example 3: Bayesian Calling for a Family Including de Novo Mutations

This example is identical to Example 2 except that it includes a probability of 0.01 in the M table for a de novo mutation of C:G to either A:G or C:A and then a selection of the de novo mutation in the child. The result is that a call that had a posterior probability of zero in Example 2 now has a posterior higher than the alternative call.

TABLE 6

| H | P(H) |
|---|---|
| A:C | 0.1 |
| C:G | 0.8 |

. . .

| Hf | Hm | Hc | M(HC\|Hf,Hm) |
|---|---|---|---|
| A:C | A:C | A:C | 0.50 |
| A:C | C:G | A:G | 0.24 |
| A:C | C:G | A:A | 0.01 |

. . .

| Father | | Mother | |
|---|---|---|---|
| Hf | P(Df\|Hf) | Hm | P(Dm\|Hm) |
| A:C | 0.125 | A:C | 0.2000 |
| C:G | 0.100 | C:G | 0.3000 |

. . .

| Child | |
|---|---|
| Hc | P(Dc\|Hc) |
| A:A | 0.350 |
| A:G | 0.007 |
| C:G | 0.250 |

. . .

| H | | | | | | |
|---|---|---|---|---|---|---|
| Hf | Hm | Hc | P(D\|H) | P(Hf)P(Hm) | M(Hc\|Hf,Hm) | P(D\|H)P(H) |
| A:C | C:G | A:G | 0.000263 | 0.080000 | 0.240000 | 0.00000504 |
| A:C | C:G | A:A | 0.013125 | 0.080000 | 0.010000 | 0.00001050 |

### 4. EMBODIMENTS

The following embodiments are to be construed as merely illustrative, and not limiting of the disclosure.
1. A method of calling a genomic sequence for a population member comprising:
   a. obtaining genomic sequence information for one or more population members;
   b. performing read alignments to generate preliminary alignments for the population members;
   c. identifying a region of interest for the population member alignments;
   d. developing hypotheses as to sequence values in the region of interest; and
   e. evaluating the probability of one or more hypothesis being correct for a plurality of population members based on the genomic sequence information.
2. A method according to embodiment 1 comprising:
   a. obtaining genomic sequence information for one or more family members;
   b. obtaining genomic sequence information for a subject family member;
   c. performing read alignments to generate preliminary alignments for the family members;
   d. identifying a region of interest for the family member alignments;
   e. developing hypotheses as to sequence values in the region of interest; and
   f. evaluating the probability of one or more hypothesis being correct for the subject and the one or more family members taking into account Mendelian inheritance rules.
3. A method according to embodiment 2 wherein the probability of a hypothesis being correct for the subject and the one or more family members is dependent upon the probability of the hypothesis occurring, independent of the genomic sequence information; the probability of the genomic sequences occurring for the hypothesis; and Mendelian inheritance rules.
4. A method according to embodiment 2 or embodiment 3 wherein the probability of a hypothesis occurring is based on historical data.
5. A method according to embodiment 2 wherein the probability of one or more hypothesis being correct for the subject and the one or more family members is calculated according to:

$$P ( H \vert D ) = \frac{\begin{matrix}P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}{\begin{matrix}\sum P ( {H}_{m} ) \times P ( {H}_{f} ) \times \prod M ( {H}_{i} \vert {H}_{m} , {H}_{f} ) \times \\ P ( {D}_{m} \vert {H}_{m} ) \times P ( {D}_{f} \vert {H}_{f} ) \times \prod P ( {D}_{i} \vert {H}_{i} )\end{matrix}}$$

where:
   P(H|D) is the probability of a hypothesis (H) being correct for all members given all the genomic sequence information (D),
   P(Hₘ)×P(H_{f}) is the probability of the hypotheses for the mother and father occurring based on historical information,
   ΠM(Hᵢ|Hₘ, H_{f}) is the Mendelian probability of the hypotheses for the i children given the hypotheses for the parents,
   P(Dₘ|Hₘ) is the probability of the genomic sequence information for a mother (Dₘ) occurring for the hypothesis for the mother (Hₘ),
   P(D_{f}|H_{f}) is the probability of the genomic sequence information for a father (D_{f}) occurring for the hypothesis for the father (H_{f}),
   ΠP(Di|Hi) is the probability of the genomic sequence information for the i children occurring for the hypotheses for the children, and
   ΣP(Hₘ)×P(H_{f})×ΠM(Hᵢ|Hₘ, H_{f})×P(Dₘ|Hₘ)×P(D_{f}|H_{f})×ΠP(Dᵢ|Hᵢ) is the sum of all probabilities for all hypotheses.
6. A method according to embodiment 5 wherein the probability of genomic sequence information occurring for a hypothesis is dependent at least in part upon a quality score for a sequencing machine of a type that provided the genomic sequence information.
7. A method according to embodiment 5 wherein the probability of genomic sequence information occurring for a hypothesis is dependent at least in part upon calibrated quality scores for the family sequences.
8. A method according to embodiment 5 wherein the probability of genomic sequence information occurring for a hypothesis is dependent at least in part upon map scores assessing the quality of mapping of a hypothesis to a particular location of a reference sequence.
9. A method according to embodiment 5 wherein the probability of genomic sequence information occurring for a hypothesis is dependent at least in part upon the chemistry of the sequences.
10. A method according to any one of embodiments 2 to 9 wherein processing is conducted one nuclear family at a time.
11. A method according to embodiment 10 wherein processing includes a plurality of nuclear families having one or more common member.
12. A method according to embodiment 11 wherein one or more probabilities associated with one or more hypotheses for one nuclear family are utilized to calculate one or more probabilities associated with one or more hypotheses for a subsequent nuclear family.
13. A method according to embodiment 11 wherein one or more probabilities associated with one or more hypotheses for one nuclear family are utilized to calculate one or more probabilities associated with one or more hypotheses for a previous nuclear family.
14. A method according to embodiment 13 wherein the probabilities of one or more hypotheses are iteratively resolved by recalculation within nuclear families.
15. A method according to embodiment 11 wherein weightings for the probability of a hypothesis occurring are propagated forward through a family from the most senior to the most junior family member.
16. A method according to embodiment 11 or embodiment 15 wherein weightings for the probability of a genomic sequences occurring for the hypothesis are propagated back through a family from the most junior to the most senior family member.
17. A method according to any one of embodiments 14 to 16 wherein iterative resolution is continued until an acceptable convergence of probabilities is achieved.
18. A method according to any preceding embodiment wherein the order of evaluation of hypotheses is based on a weighting of hypotheses.
19. A method according to embodiment 18 wherein the weighting of hypotheses is on a graduated scale.
20. A method according to embodiment 19 wherein the weighting is at least in part dependent upon the frequency of occurrence of one or more sequence values.
21. A method according to embodiment 19 or embodiment 20 wherein hypotheses are evaluated from the hypotheses having the highest weighting to those having the lowest weighting.
22. A method according to embodiment 21 wherein processing is terminated if an acceptance criteria is met.
23. A method according to embodiment 22 wherein the acceptance criteria is a probability threshold.
24. A method according to embodiment 22 wherein the acceptance criteria is based on a trend in probabilities from evaluation.
25. A method according to embodiment 18 wherein hypotheses that do not comply with Mendelian inheritance rules are excluded.
26. A method according to any one of the preceding embodiments wherein hypotheses developed in step e of embodiment 2 are filtered.
27. A method as according to embodiment 26 wherein hypotheses having a frequency of occurrence below a threshold level are filtered out.
28. A method according to embodiment 26 wherein hypotheses having a low frequency of occurrence in similar populations from historic SNP data are filtered out.
29. A method according to any one of the preceding embodiments wherein the probability of an hypothesis occurring is iteratively resolved by:
   a. calling sequences for population members based on historical probability data as to the probability of an hypothesis occurring;
   b. combining the called sequences for population members with the historical probability data to produce combined historical data;
   c. re-calling sequences for population members based on the combined historical data as to the probability of an hypothesis occurring; and
   d. repeating steps b and c until a desired convergence is achieved.
30. A method according to embodiment 29 wherein in step b the called sequence information is combined with the historical probability data based on the probability of a haploid occurring.
31. A method according to embodiment 29 wherein in step b the called sequence information is combined with the historical probability data based on the probability of a diploid occurring.
32. A method according to any one of embodiments 29 to 31 wherein steps b and c are repeated until there is no change in sequence calling.
33. A method according to embodiment 1 wherein the probability of an hypothesis occurring is iteratively resolved by:
   a. calling sequences for population members based on historical probability data as to the probability of an hypothesis occurring;
   b. combining the called sequences for population members with the historical probability data to produce combined historical data;
   c. re-calling sequences for population members based on the combined historical data as to the probability of an hypothesis occurring;
   d. repeating steps b and c until a desired convergence is achieved.
34. A method according to embodiment 33 wherein in step b the called sequence information is combined with the historical probability data based on the probability of a haploid occurring.
35. A method according to embodiment 33 wherein in step b the called sequence information is combined with the historical probability data based on the probability of a diploid occurring.
36. A method according to any one of embodiments 33 to 35 wherein steps b and c are repeated until there is no change in sequence calling.
37. A method according to embodiment 3 when conducted for a plurality of members of a population further comprising the steps of:
   a. calculating the probability of each hypothesis for each member;
   b. calculating forward propagation values on the basis of a member and its ancestors and propagating these values down to the generation below;
   c. calculating backwards propagation values on the basis of a member and its descendants and propagating these values up to the generation above;
   d. recalculating each hypothesis utilising the forward and backwards propagation values; and
   e. repeating steps b to d until acceptable convergence is achieved.
38. A method according to embodiment 37 wherein acceptable convergence is reached when there is no further change between iterations.
39. A method according to embodiment 37 wherein acceptable convergence is reached when an acceptance criteria is met.
40. A method according to any one of embodiments 37 to 39 wherein the forward propagation values are based on each member's priors, the member model its ancestor models and Mendelian inheritance.
41. A method according to any one of embodiments 37 to 40 wherein the backwards propagation values are based on the member's priors, the member model, Mendelian inheritance and the models of its descendants.
42. A method according to any one of embodiments 37 to 41 wherein no genomic sequence information is available for a population member and its genomic sequence is called based on inferred values.
43. A method according to any one of the preceding embodiments wherein the genomic sequence information consists of sets of reads for each family member obtained from a sequencing machine.
44. A method according to any one of the preceding embodiments wherein the region of interest is a single sequence value.
45. A method according to any one of the preceding embodiments wherein the region of interest includes multiple sequence values.
46. A method according to any one of the preceding embodiments wherein the sequences are DNA sequences.
47. A method according to any one of the preceding embodiments wherein the sequences are RNA sequences.
48. A method according to any one of the preceding embodiments wherein the sequences are protein sequences.
49. A system for implementing the method of any one of the preceding embodiments.
50. A method according to any one of embodiments 1 to 18 wherein the genomic sequence information is a plurality of reads and at least some hypotheses are generated using an assembly of reads.
51. A method according to embodiment 50 wherein reads associated with aligned reads are included in an assembly of reads.
52. A method according to embodiment 51 wherein association includes matching paired end reads.
53. A method according to embodiment 50 wherein reads associated with external reference sequences are combined to form assemblies of reads.
54. A method according to embodiments 50-53 wherein the reads are combined across multiple samples.
55. A method according to any one of the preceding embodiments wherein the evaluation of an hypothesis includes evaluation of one or more non-Mendelian mechanisms that may cause a de novo mutation.
56. A method according to embodiment 55 wherein population factors are taken into account in the assessment of the probability of a de novo mutation.
57. A method according to embodiment 55 or embodiment 56 wherein environmental factors are taken into account in the assessment of the probability of a de novo mutation.
58. A method according to any one of the preceding embodiments when dependent upon embodiment 5 wherein the Mendelian probability of the hypothesis for the child given the hypotheses for the parents M(H_{c}|Hₘ, H_{f}) incorporates one or more probabilities associated with the likelihood of one or more non-Mendelian mechanisms causing a de novo mutation.

Additional embodiments include:
1. A computer implemented method of calling a genomic sequence for a sample from a subject potentially containing normal and cancerous material comprising:
   a. sequencing a potentially mixed sample of normal and cancerous genomic material to obtain reads for the sample;
   b. performing read alignment to generate preliminary read alignments for the sample;
   c. identifying a region of interest of the preliminary alignments;
   d. developing hypotheses as to sequence values in the region of interest; and
   e. evaluating the probability of normal sequence and cancerous sequence values based on the reads; normal genomic sequence information and a contamination factor.
2. A method according to embodiment 1 wherein the probability of normal sequence and cancerous sequence values for the subject is dependent upon the probability of the hypothesis occurring, independent of the reads; the probability of the reads occurring for the hypothesis; and a contamination factor.
3. A method according to embodiment 2 wherein the probability of a hypothesis that a sample contains cancerous and normal biological material is calculated according to:

$$P ( Hn , Hc \vert En , Ec ) = \frac{P ( En \vert Hn ) P ( Ec \vert Hn , Hc ) P ( Hn ) Q ( Hc \vert Hn )}{P ( E )}$$

where:
   P(Hn,Hc|En,Ec) is the probability for a hypothesis as to normal (Hn) and cancerous (Hc) sequence values given the evidence (reads) for normal (En) and cancerous (Ec) samples

$$P ( En \vert Hn ) = {π}_{en EN} P ( {e}_{n} \vert Hn )$$

$$P ( Ec \vert Hn , Hc ) = {π}_{en EN} P ( {e}_{c} \vert Hn , Hc )$$

$$P ( ec \vert Hn , Hc ) = α P ( ec \vert Hn ) + ( 1 - α ) P ( ec \vert Hc )$$

α is the contamination factor
P(Hₙ) is the probability of the normal hypotheses occurring based on reference information as to the normal genomic sequence,
Q(H_{c}|Hₙ) is the probability of a transition from Hn to Hc, and
P(E) is the sum of all probabilities for all hypotheses used to normalize the resulting probability.
4. A method according to any one of the preceding embodiments wherein the sample includes an homologous pair of chromosomes and the hypotheses include hypotheses for each of the homologous pair of chromosomes.
5. A method according to embodiment 4 wherein copy number weighting factors are associated with each of the homologous pair of chromosomes.
6. A method according to embodiment 5 wherein the probability of a hypothesis that a sample contains cancerous and normal biological material is calculated where:

P(Ec|Hn,Hc)=αP(ec|Hn)+(1−α)(a/(a+b)P(ec|H′c)+b/(a+b)P(ec|H″c))
where:
H′c is the hypothesis for one of an homologous pair of chromosomes
a is a weighting related to the number of copies of H′c
H″c is the hypothesis for the other one of the homologous pair of chromosomes
b is a weighting related to the number of copies of H″c
7. A method according to embodiment 5 or embodiment 6 wherein copy numbers are estimated based on the total number of reads in a normal sample and the number of reads in a potentially cancerous sample.
8. A method according to embodiment 5 or embodiment 6 wherein copy numbers are estimated at a plurality of locations based on the number of reads in a normal sample and the number of reads in a potentially cancerous sample after alignment.
9. A method according to embodiment 5 or embodiment 6 wherein copy numbers are estimated at a location where a normal or target cancerous sequence is known to have a distinctive sequence based on the number of reads in a normal sample and the number of reads in a potentially cancerous sample.
10. A method according to any one of the preceding embodiments wherein a region of interest is a complex calling region.
11. A method according to any one of the preceding embodiments wherein the hypotheses are the reads occurring in the region of interest.
12. A method according to any one of the preceding embodiments wherein the hypotheses include known cancerous sequences.
13. A method according to any one of the preceding embodiments wherein normal genomic sequence information is obtained from sequencing a sample from the subject considered likely to contain only normal genomic sequence information.
14. A method according to any one embodiments 1 to 12 wherein normal genomic sequence information is obtained from a human genome reference source.
15. A method according to any one embodiments 1 to 12 wherein normal genomic sequence information is obtained from sequencing a sample of the subject at a prior time.
16. A method according to any one of the preceding embodiments wherein the contamination factor is based on an expert determination.
17. A method according to any one of embodiments 1 to 15 wherein the contamination factor is based on clinical information.
18. A method according to any one of embodiments 1 to 15 wherein the contamination factor is based on a comparison of the ratio of normal and cancerous genomic sequence values in one or more specified regions.
19. A method according to embodiment 18 wherein the specified region is selected based on distinctiveness the normal and cancerous genomic sequences in the specified region.
20. A method according to any one of embodiments 1 to 15 wherein the contamination factor is determined using an optimization process.
21. A method according to embodiment 20 wherein the global probability is used as the measure of goodness for the optimization process.
22. A computer implemented method of calling a genomic sequence for a sample including diploid genetic sequences potentially containing normal and cancerous material comprising:
   a. sequencing the sample of potentially normal and cancerous genomic material to obtain reads for the sample;
   b. performing read alignment to generate preliminary read alignments for the sample;
   c. identifying a region of interest of the preliminary alignments;
   d. developing hypotheses as to sequence values for each of the homologous pair of chromosomes in the region of interest; and
   e. evaluating the probability of normal sequence and cancerous sequence values based on the reads; normal genomic sequence information and copy number weighting factors associated with each of the homologous pair of chromosomes.
23. A method of calling a genomic sequence for a sample from a biological entity in a collection of related biological entities, performed by one or more processors executing program instructions stored on one or more memories, causing the one or more processors to perform the method comprising:
   a. obtaining genomic sequence information for one or more samples from one or more biological entities;
   b. performing read alignments to generate preliminary alignments for the samples;
   c. identifying a region of interest for the alignments;
   d. developing hypotheses as to sequence values in the region of interest; and
   e. evaluating the probability of one or more hypothesis being correct for a plurality of sequence values based on the genomic sequence information.
24. The method of embodiment 23, wherein the evaluation of an hypothesis incorporates the possibility of de novo mutations.
25. The method of embodiment 24, wherein population factors are taken into account in the assessment of the probability of de novo mutations.
26. The method of embodiment 24, wherein environmental factors are taken into account in the assessment of the probability of de novo mutations.

Still further embodiments include:

1. A method of calling a target biological sequence of a biological sequence source based on a set of sequence reads, the method performed by one or more processors executing program instructions stored on one or more memories, the instructions causing the one or more processors to perform the method comprising:

obtaining biological sequence read information from a target biological sequence source and a second biological sequence source, wherein the target source and the second source are genetically related;

modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source; and
a biological sequence of the second biological sequence source; and
one or more random variables chosen from:
   contamination of a set of sequence reads that correspond to a biological sequence source;
   the copy number of a genomic sequence of a biological sequence source;
   the presence of de novo mutation in a genomic sequence of a biological sequence source; and
   a phenotypic trait; and

providing one or more likely values for one or more random variables in the set of random variables.

2. The method of embodiment 1, wherein the step of providing one or more likely values for one or more random variable in the set of random variables comprises providing one or more likely values for the biological sequence of the target biological sequence source.
3. The method of embodiment 1, wherein the step of obtaining the biological sequence read information comprises sequencing one or more biological samples using a DNA sequencing machine.
4. The method of embodiment 1, wherein the step of obtaining the biological sequence read information comprises amplifying DNA in one or more biological samples.
5. The method of embodiment 1, wherein the sequence read information represents DNA, RNA, or protein sequences.
6. The method of embodiment 1, wherein the one or more likely values for the biological sequence of the target source represents the entirety of at least one chromosomal sequence or an amount of sequence equivalent to the entirety of at least one chromosomal sequence.
7. The method of embodiment 1, wherein the one or more likely values for the genomic sequence of the target source represents a subset of one chromosomal sequence.
8. The method of embodiment 1, wherein the method further comprises providing one or more scores indicating the confidence associated with the one or more likely values for one or more random variable in the set of random variables.
9. The method of embodiment 1, wherein the step of modeling the probabilities of occurrence of possible values of a set of random variables incorporates the possibility that a read is incorrectly mapped.
10. The method of embodiment 1, wherein the step of obtaining the biological sequence read information further comprises obtaining biological sequence read information from one or more additional biological sequence sources;

wherein the set of random variables further comprises one or more subsets of variables comprising: the set of sequence reads, biological sequence, copy number, and/or presence of de novo mutation; and

wherein each subset of variables is associated with the one or more additional biological sequence sources.

11. The method of embodiment 10, wherein at least some of the biological sequence read information from at least one biological sequence source is estimated from extrinsic data.
12. The method of embodiment 10, wherein the biological sequence sources comprise a pedigree of at least five family members.
13. The method of embodiment 10, wherein the second biological sequence source is an individual with a degree of relationship of one to four to the target biological sequence source.
14. The method of embodiment 10, wherein the biological sequence sources comprise parents, siblings, half-siblings, or children of the target biological sequence source.
15. The method of embodiment 1, wherein the set of random variables comprises contamination of a set of sequence reads that correspond to a biological sequence source.
16. The method of embodiment 1, wherein the set of random variables comprises the copy number of a genomic sequence of a biological sequence source.
17. The method of embodiment 1, wherein the set of random variables comprises the presence of de novo mutation in a genomic sequence of a biological sequence source.
18. The method of embodiment 1, wherein the set of random variables further comprises at least one variable representing at least one phenotypic trait and a variable representing a genetic explanation for the at least one phenotypic trait.
19. A method of calling a target biological sequence of a biological sequence source based on a set of sequence reads, the method performed by one or more processors executing program instructions stored on one or more memories, the instructions causing the one or more processors to perform the method comprising:

obtaining biological sequence read information from a target biological sequence source and a second biological sequence source, wherein the target source and the second source are genetically related, and wherein the target source and the second source are not two members of a family of individual organisms;

modeling probabilities of occurrence of possible values of a set of random variables using a Bayesian network, the set of random variables comprising:
a set of sequence reads that correspond to the target biological sequence source;
a biological sequence of the target biological sequence source;
a set of sequence reads that correspond to the second biological sequence source;
a biological sequence of the second biological sequence source; and
a variable representing contamination of a set of sequence reads that correspond to a biological sequence source; and

providing one or more likely values for one or more random variables in the set of random variables.

20. The method of embodiment 19, wherein the target biological sequence source comprises cancerous or pre-cancerous cells or tissue of an individual, and the second biological source comprises noncancerous cells or tissue of the individual.
21. The method of embodiment 19, wherein the target biological sequence source and the second biological source were sampled at different time points.
22. The method of embodiment 19, wherein the target biological sequence source and the second biological source are two different cell lines.
23. A system for calling a target biological sequence of a biological sequence source based on a set of sequence reads, the system comprising:

one or more processors configured to execute one or more modules; and

a memory storing the one or more modules, the modules comprising:
code for obtaining biological sequence read information from a target biological sequence source and a second biological sequence source, wherein the target source and the second source are genetically related;
code for modeling the probabilities of occurrence of the possible values of a set of random variables using a Bayesian network, the set of random variables comprising:
   a set of sequence reads that correspond to the target biological sequence source;
   a biological sequence of the target biological sequence source;
   a set of sequence reads that correspond to the second biological sequence source; and
   a biological sequence of the second biological sequence source; and
   one or more random variables chosen from:
      contamination of a set of sequence reads that correspond to a biological sequence source;
      the copy number of a biological sequence of a biological sequence source;
      the presence of de novo mutation in a biological sequence of a biological sequence source; and
      a phenotypic trait;
   and
code for providing one or more likely values for the biological sequence of the target source and/or one or more likely values for the biological sequence of the second biological sequence source.
   24. The system of embodiment 23, further comprising a nucleic acid sequencer configured to provide biological sequence read information to the one or more modules.
   25. The system of embodiment 24, wherein the sequencer is locally interfaced with the one or more modules or connected to the one or more modules through a network.

Additional embodiments include:

1. A method of calling a target biological sequence of a target biological sequence source based on a set of sequence reads, the method performed by one or more processors executing program instructions stored on one or more memories, the instructions causing the one or more processors to perform the method comprising:
obtaining biological sequence read information from the target biological sequence source and a second biological sequence source, wherein the target source and the second source are genetically related;
determining a joint probability distribution for a set of random variables of a Bayesian network, the set of random variables comprising:
   a set of target sequence reads that correspond to the target biological sequence source,
   a target biological sequence of the target biological sequence source, the target biological sequence an immediate parent in the Bayesian network to the target sequence reads,
   a set of second sequence reads that correspond to the second biological sequence source,
   a second biological sequence of the second biological sequence source, the second biological sequence an immediate parent in the Bayesian network to the second sequence reads and a parent in the Bayesian network to the target biological sequence,
   at least one of a selection copy random variable and a local mutation random variable, the target biological sequence a child in the Bayesian network to the at least one of the selection copy random variable and the local mutation random variable,
   determining, based on the joint probability distribution, a conditional probability distribution for the target biological sequence given the set of target sequence reads and the set of second sequence reads; and
   providing an estimate of the biological sequence of the target biological sequence source based on the conditional probability distribution and the biological sequence read information.
      2. The method of embodiment 1, wherein the step of obtaining the biological sequence read information comprises sequencing one or more biological samples using a DNA sequencing machine.
      3. The method of embodiment 1, wherein the step of obtaining the biological sequence read information comprises amplifying DNA in one or more biological samples.
      4. The method of embodiment 1, wherein the biological sequence read information represents DNA, RNA, or protein sequences.
      5. The method of embodiment I, wherein the estimate of the biological sequence of the target biological sequence source represents the entirety of at least one chromosomal sequence or an amount of sequence equivalent to the entirety of at least one chromosomal sequence.
      6. The method of embodiment I, wherein the estimate of the biological sequence of the target biological sequence source represents a subset of one chromosomal sequence.
      7. The method of embodiment 1, wherein the method further comprises providing one or more scores indicating a confidence associated with the estimate of the biological sequence of the target biological sequence source.
      8. The method of embodiment 1, wherein the joint probability distribution for the set of random variables incorporates the possibility that a read is incorrectly mapped.
      9. The method of embodiment 1, wherein the step of obtaining the biological sequence read information further comprises obtaining the biological sequence read information, in part, from one or more additional biological sequence sources;
wherein the set of random variables further comprises one or more subsets of variables comprising:
   a set of additional sequence reads that corresponds to one of the one or more additional biological sequence sources.
   an additional biological sequence of the additional biological sequence source, the additional biological sequence an immediate parent in the Bayesian network to the additional sequence reads and a parent in the Bayesian network to the target biological sequence, and
   at least one of an additional selection copy random variable and an additional local mutation random variable, the target biological sequence a child in the Bayesian network to the at least one of the additional selection copy random variable and the additional local mutation random variable.
      10. The method of embodiment 9, wherein at least some of the biological sequence read information from at least one biological sequence source is estimated from extrinsic data.
      11. The method of embodiment 9, wherein the target biological sequence source, the second biological sequence source, and the one or more additional biological sequence sources comprise a pedigree of at least five family members.
      12. The method of embodiment 9, wherein the second biological sequence source is an individual with a degree of relationship of one to four to the target biological sequence source.
      13. The method of embodiment 9, wherein the second biological sequence source and the one or more additional biological sequence sources comprise parents and at least one of a sibling, half-sibling, and child of the target biological sequence source.
      14. The method of embodiment 1, wherein the step of determining a joint probability distribution for the set of random variables comprises determining, for ones of the set of random variables with immediate parents in the Bayesian network, conditional probability distributions given the immediate parents in the Bayesian network.
      15. The method of embodiment 1, wherein the step of determining a joint probability distribution for the set of random variables comprises determining:
a product of, at least in part, of the conditional probability of the target biological sequence reads given the target biological sequence and the conditional probability of the target biological sequence given the one or more immediate parents of the target biological sequence in the Bayesian network.
   16. The method of embodiment I, wherein the set of random variables comprises a de novo mutation random variable that is an immediate child in the Bayesian network to the at least one of the selection copy random variable and the local mutation random variable, and wherein the method further comprises:
determining, based on the joint probability distribution, a conditional probability distribution for the de novo mutation random variable given the set of target sequence reads and the set of second sequence reads: and
providing an estimate of the de novo mutation random variable based on the conditional probability distribution and the biological sequence read information.
   17. A method of calling a target biological sequence of a target biological sequence source based on a set of sequence reads, the method performed by one or more processors executing program instructions stored on one or more memories, the instructions causing the one or more processors to perform the method comprising.
obtaining biological sequence read information from the target biological sequence source and a second biological sequence source, wherein the target biological sequence source and the second biological sequence source are genetically related, and wherein the target biological sequence source and the second biological sequence source are not two members of a family of individual organisms;
determining a joint probability distribution for a set of random variables of a Bayesian network, the set of random variables comprising:
   a set of target sequence reads that correspond to the target biological sequence source,
   a contamination random variable that is an immediate parent in the Bayesian network to the target sequence reads,
   a target biological sequence of the target biological sequence source, the target biological sequence an immediate parent to the target sequence reads,
   a set of second sequence reads that correspond to the second biological sequence source, and
   a second biological sequence of the second biological sequence source that is an immediate parent in the Bayesian network to the second sequence reads and a parent in the Bayesian network to the target biological sequence;
determining, based on the joint probability distribution, a conditional probability distribution for the target biological sequence given the set of target sequence reads and the set of second sequence reads; and
providing an estimate of the biological sequence of the target biological sequence source based on the conditional probability distribution and the biological sequence read information.
   18. The method of embodiment 17, wherein the target biological sequence source comprises cancerous or pre-cancerous cells or tissue of an individual, and the second biological source comprises noncancerous cells or tissue of the individual.
   19. The method of embodiment 17, wherein the target biological sequence source and the second biological source were sampled at different time points.
   20. The method of embodiment 17, wherein the target biological sequence source and the second biological source are two different cell lines.
   21. A method of calling a target biological sequence of a biological sequence source based on a set of sequence reads, the method performed by one or more processors executing program instructions stored on one or more memories, the instructions causing the one or more processors to perform the method comprising:
obtaining biological sequence read information from a target biological sequence source and a second biological sequence source, wherein the target source and the second source are genetically related;
determining a conditional probability distribution for the target biological sequence given the set of target sequence reads and the set of second sequence reads using a joint probability distribution for a Bayesian network comprising:
   a set of target sequence read random variables that correspond to the target biological sequence source,
   a target biological sequence random variable of the target biological sequence source, the target biological sequence random variable an immediate parent in the Bayesian network to the target sequence read random variables,
   a set of second sequence read random variables that correspond to the second biological sequence source,
   a second biological sequence random variable of the second biological sequence source, the second biological sequence random variable an immediate parent in the Bayesian network to the second sequence read random variables and a parent in the Bayesian network to the target biological sequence random variable,
   at least one of a selection copy random variable and a local mutation random variable, the target biological sequence random variable a child in the Bayesian network to the at least one of the selection copy random variable and the local mutation random variable; and
providing an estimate of the biological sequence of the target biological sequence source based on the conditional probability distribution and the biological sequence read information.
   22. The method of embodiment 21, wherein the step of obtaining the biological sequence read information further comprises obtaining the biological sequence read information, in part, from one or more additional biological sequence sources; and wherein the Bayesian network further comprises:
a set of additional sequence read random variables that correspond to one of the one or more additional biological sequence sources,
an additional biological sequence random variable of the additional biological sequence source, the additional biological sequence random variable an immediate parent in the Bayesian network to the additional sequence read random variables and a parent in the Bayesian network to the target biological sequence random variable,
at least one of an additional selection copy random variable and an additional local mutation random variable, the target biological sequence random variable a child in the Bayesian network to the at least one of the additional selection copy random variable and the additional local mutation random variable.
   23. The method of embodiment 21, wherein the joint probability distribution comprises a product of conditional probability distributions for random variables in the Bayesian network, given the immediate parents of the random variables in the Bayesian network.
   24. The method of embodiment 21, wherein the joint probability distribution comprises a product of, at least in part, the conditional probability of the target biological sequence read random variables given the target biological sequence random variable and the conditional probability of the target biological sequence random variable given the one or more immediate parents of the target biological sequence random variable in the Bayesian network.
   25. The method of embodiment 21, wherein the method further comprises indicating a confidence for the estimated biological sequence of the target biological sequence source.
   26. A method of calling a genomic sequence, performed by one or more processors executing program instructions stored on one or more memories, causing the one or more processors to perform the method comprising:
obtaining a pedigree for a related population that includes a member and at least one ancestor of the member:
obtaining genomic sequence information for the related population, the genomic sequence information comprising reads;
identifying a region of interest based on the aligned reads;
   constructing potential sequences for the region of interest;
iteratively evaluating probabilities that the potential sequences correspond to a sequence of the region of interest based on the pedigree and the genomic sequence information, an iteration comprising:
   updating an above value for the member based in part on above values and posterior probabilities for the at least one ancestor.
   updating below values for the at least one ancestor based in part on a below value and a posterior probability for the member, and
   recalculating the probabilities that the potential sequences correspond to the sequence of the region of interest using the updated above values for the member and the at least one ancestor, the posterior probabilities for the member and the at least one ancestor, and the updated below values for the member and the at least one ancestor: and
providing an indication of at least one of the probabilities.
   27. The method of embodiment 26, wherein the iterative evaluation further accounts for Mendelian inheritance rules.
   28. The method of embodiment 26, wherein the iterative evaluation further accounts for historical data.
   29. The method of embodiment 26, wherein the iterative evaluation further accounts for a quality score for a sequencing machine of a type that provided the genomic sequence information.
   30. The method of embodiment 26, wherein the reads comprise reads for one or more samples obtained from the member.
   31. The method of embodiment 26, wherein the reads comprise reads obtained using a SNP chip.
   32. The method of embodiment 26, wherein the iterative evaluation further accounts for map scores that indicate a number of potential mappings of a sequence to a reference sequence.
   33. The method of embodiment 26, further comprising calling another genomic sequence using genomic sequence information for another related population and at least one of the potential sequences for the region of interest.
   34 The method of embodiment 26, wherein providing the indication of the at least one of the probabilities comprises calling the most likely one of the potential sequences as the sequence of the region of interest.
   35. The method of embodiment 26, wherein providing the indication of the at least one of the probabilities comprises providing the probabilities that the potential sequences correspond to the sequence of the region of interest for some of the potential sequences.
   36. The method of embodiment 26, wherein the genomic sequence information comprises inferred values for one of the related population.
   37. The method of embodiment 26, wherein the genomic sequences information comprises at least one of DNA sequences and RNA sequences.
   38. A system for calling a genomic sequence for a sample from a biological entity in a collection of related biological entities, the system comprising:
one or more processors configured to execute one or more modules, and a memory storing the one or more modules, the modules comprising:
   code for obtaining genomic sequence information for one or more samples from one or more biological entities;
   code for performing read alignments to generate preliminary alignments for the samples;
   code for identifying a region of interest for the alignments;
   code for developing hypotheses as to sequence values in the region of interest; and
   code for evaluating the probability of one or more hypothesis being correct for a plurality of sequence values based on the genomic sequence information.
      39. A method of calling a genomic sequence for a sample from a subject potentially containing normal and cancerous material, performed by one or more processors executing program instructions stored on one or more memories, causing the one or more processors to perform the method comprising:
sequencing the potentially mixed sample of normal and cancerous genomic material to obtain reads for the sample;
performing read alignments to generate preliminary alignments for the samples;
identifying a region of interest for the alignments;
developing hypotheses as to sequence values in the region of interest; and
evaluating the probability of normal sequence and cancerous sequence values based on the reads, normal genomic sequence information, and a contamination factor.
   40. The method of embodiment 39, wherein the sample includes a homologous pair of chromosomes, and the hypotheses include hypotheses for each of the homologous pair of chromosomes, and wherein copy number weighting factors are associated with each of the homologous pair of chromosomes.

Other embodiments of the invention will be apparent to those skilled in the art from consideration of the specification and practice of the invention disclosed herein. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept. It is intended that the specification and examples be considered as exemplary only, with a true scope and spirit of the invention being indicated by the following claims.

While the present invention has been illustrated by the description of the embodiments thereof, and while the embodiments have been described in detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the applicant's general inventive concept.

What is claimed is:

1. A method of calling a target biological sequence of a target biological sequence source based on a set of sequence reads, the method performed by one or more processors executing program instructions stored on one or more memories, the instructions causing the one or more processors to perform the method comprising:
obtaining biological sequence read information from the target biological sequence source and a second biological sequence source, wherein the target source and the second source are genetically related;
determining a joint probability distribution for a set of random variables of a Bayesian network, the set of random variables comprising:
a set of target sequence reads that correspond to the target biological sequence source,
a target biological sequence of the target biological sequence source, the target biological sequence an immediate parent in the Bayesian network to the target sequence reads,
a set of second sequence reads that correspond to the second biological sequence source,
a second biological sequence of the second biological sequence source, the second biological sequence an immediate parent in the Bayesian network to the second sequence reads and a parent in the Bayesian network to the target biological sequence,
at least one of a selection copy random variable and a local mutation random variable, the target biological sequence a child in the Bayesian network to the at least one of the selection copy random variable and the local mutation random variable;
determining, based on the joint probability distribution, a conditional probability distribution for the target biological sequence given the set of target sequence reads and the set of second sequence reads; and
providing an estimate of the biological sequence of the target biological sequence source based on the conditional probability distribution and the biological sequence read information.

2. The method of claim 1, wherein the step of obtaining the biological sequence read information comprises sequencing one or more biological samples using a DNA sequencing machine and amplifying DNA in the one or more biological samples.

3. The method of claim 1, wherein the estimate of the biological sequence of the target biological sequence source represents the entirety of at least one chromosomal sequence or an amount of sequence equivalent to the entirety of at least one chromosomal sequence.

4. The method of claim 1, wherein the method further comprises providing one or more scores indicating a confidence associated with the estimate of the biological sequence of the target biological sequence source.

5. The method of claim 1, wherein the step of obtaining the biological sequence read information further comprises obtaining the biological sequence read information, in part, from one or more additional biological sequence sources;
wherein the set of random variables further comprises one or more subsets of variables comprising:
a set of additional sequence reads that corresponds to one of the one or more additional biological sequence sources,
an additional biological sequence of the additional biological sequence source, the additional biological sequence an immediate parent in the Bayesian network to the additional sequence reads and a parent in the Bayesian network to the target biological sequence, and
at least one of an additional selection copy random variable and an additional local mutation random variable, the target biological sequence a child in the Bayesian network to the at least one of the additional selection copy random variable and the additional local mutation random variable.

6. The method of claim 5, wherein at least some of the biological sequence read information from at least one biological sequence source is estimated from extrinsic data.

7. The method of claim 5, wherein the target biological sequence source, the second biological sequence source, and the one or more additional biological sequence sources comprise a pedigree of at least five family members.

8. The method of claim 5, wherein the second biological sequence source is an individual with a degree of relationship of one to four to the target biological sequence source.

9. The method of claim 5, wherein the second biological sequence source and the one or more additional biological sequence sources comprise parents and at least one of a sibling, half-sibling, and child of the target biological sequence source.

10. The method of claim 1, wherein the step of determining a joint probability distribution for the set of random variables comprises determining, for ones of the set of random variables with immediate parents in the Bayesian network, conditional probability distributions given the immediate parents in the Bayesian network.

11. The method of claim 1, wherein the step of determining a joint probability distribution for the set of random variables comprises determining:
a product of, at least in part, of the conditional probability of the target biological sequence reads given the target biological sequence and the conditional probability of the target biological sequence given the one or more immediate parents of the target biological sequence in the Bayesian network.

12. The method of claim 1, wherein the set of random variables comprises a de novo mutation random variable that is an immediate child in the Bayesian network to the at least one of the selection copy random variable and the local mutation random variable, and wherein the method further comprises:
determining, based on the joint probability distribution, a conditional probability distribution for the de novo mutation random variable given the set of target sequence reads and the set of second sequence reads; and
providing an estimate of the de novo mutation random variable based on the conditional probability distribution and the biological sequence read information.

13. A method of calling a genomic sequence, performed by one or more processors executing program instructions stored on one or more memories, causing the one or more processors to perform the method comprising:
obtaining a pedigree for a related population that includes a member and at least one ancestor of the member:
obtaining genomic sequence information for the related population, the genomic sequence information comprising reads;
identifying a region of interest based on the aligned reads;
constructing potential sequences for the region of interest;
iteratively evaluating probabilities that the potential sequences correspond to a sequence of the region of interest based on the pedigree and the genomic sequence information, an iteration comprising:
updating an above value for the member based in part on above values and posterior probabilities for the at least one ancestor,
updating below values for the at least one ancestor based in part on a below value and a posterior probability for the member, and
recalculating the probabilities that the potential sequences correspond to the sequence of the region of interest using the updated above values for the member and the at least one ancestor, the posterior probabilities for the member and the at least one ancestor, and the updated below values for the member and the at least one ancestor; and
providing an indication of at least one of the probabilities.

14. The method of claim 13, wherein the iterative evaluation further accounts for Mendelian inheritance rules historical data, and a quality score for a sequencing machine of a type that provided the genomic sequence information.

15. The method of claim 13, wherein the reads comprise reads for one or more samples obtained from the member.

16. The method of claim 13, wherein the iterative evaluation further accounts for map scores that indicate a number of potential mappings of a sequence to a reference sequence.

17. The method of claim 13, further comprising calling another genomic sequence using genomic sequence information for another related population and at least one of the potential sequences for the region of interest.

18. The method of claim 13, wherein providing the indication of the at least one of the probabilities comprises calling the most likely one of the potential sequences as the sequence of the region of interest.

19. The method of claim 13, wherein providing the indication of the at least one of the probabilities comprises providing the probabilities that the potential sequences correspond to the sequence of the region of interest for some of the potential sequences.

20. The method of claim 3, wherein the genomic sequence information comprises inferred values for one of the related population.
